(19) United States
(12) Patent Application Publication
(10) Pub. No.: US 2013/0100344 A1
(43) Pub. Date: Apr. 25, 2013

(54) ACCESSORY AND IMAGING DEVICE

(71) Applicant: Kazuto KIKUCHI, Kanagawa (JP)

(72) Inventor: Kazuto KIKUCHI, Kanagawa (JP)

(73) Assignee: Sony Corporation, Tokyo (JP)

(21) Appl. No.: 13/596,329

(22) Filed: Aug. 28, 2012

(30) Foreign Application Priority Data
Oct. 24, 2011 (JP) 2011-232776

(51) Int. Cl. H04N 5/225

(52) U.S. Cl. 348/375; 348/E05.028

(57) ABSTRACT

An accessory includes: a connecting section which is connected to a mount section provided in a device main body; an operating lever operated and moved in a predetermined direction; and a body supporting the operating lever; and a bayonet connection method by which the accessory is properly positioned on the device main body and the whole of the accessory is rotated to connect the connecting section to the mount section and attach the accessory to the device main body or a spigot connection method by which the accessory is properly positioned on the device main body and the operating lever is operated to connect the connecting section to the mount section and attach the accessory to the device main body can be selected.

### BACKGROUND

The present technology relates to the field of technology related to accessories and imaging devices. Specifically, the present technology relates to the field of technology for making it easier to attach or detach an accessory to or from a device main body by allowing a bayonet connection method by which the accessory is attached to the device main body by rotation of a body or a spigot connection method by which the accessory is attached to the device main body by the operation of an operating lever to be selected as a method for attaching the accessory to the device main body.

As an imaging device such as a still camera, there is an imaging device that allows an interchangeable lens to be attached to or detached from a front face of a device main body, and the functionality thereof is enhanced by an interchangeable lens attached thereto. Moreover, the interchangeable lens is sometimes attached to the device main body via an adapter, and the interchangeable lens and the adapter are used as accessories of the imaging device.

In such an imaging device to or from which these accessories can be attached or detached, as a method for attaching the accessory to the device main body, there are a so-called bayonet connection method by which the whole of the accessory is rotated with respect to the device main body to bring an engagement section of the accessory into engagement with an engagement section of the device main body and a so-called spigot connection method by which the engagement section of the accessory is brought into engagement with the engagement section of the device main body by the operation of an operating lever provided in the accessory or the device main body (for example, see Japanese Unexamined Patent Application Publication No. 06-51386).

In the bayonet connection method, the whole of the accessory is rotated at a certain angle in a state in which the accessory is pressed against the front face of the device main body from the front to attach the accessory to the device main body.

In such a bayonet connection method, since there is no operating lever, the structure of the accessory is simple. However, since the whole of the accessory is rotated with respect to the device main body, it is necessary to provide the individual sections of the device main body in positions away from the rotation path of the accessory to avoid interference with the accessory. This decreases flexibility in designing the imaging device.

On the other hand, in the spigot connection method, the accessory is rotated at a certain angle by the operation of the operating lever in a state in which the accessory is pressed against the front face of the device main body from the front to attach the accessory to the device main body.

In such a spigot connection method, it is not necessary to rotate the whole of the accessory with respect to the device main body because the accessory is attached to the device main body by the operation of the operating lever. This increases flexibility in designing the imaging device. Moreover, it is not necessary to rotate the whole of a heavy accessory. This makes it possible to attach or detach the accessory to or from the device main body with ease.

### SUMMARY

Incidentally, as the above-described imaging device to which the accessory can be attached to or detached from the device main body, there is an imaging device that allows a plurality of types of accessories to be individually attached to or detached from the device main body, and these accessories have different shapes and sizes.

Therefore, when a method for attaching the accessory to the device main body is fixed, it may be difficult to attach or detach some types of accessories to or from the device main body or it may take time and effort to attach or detach these accessories to or from the device main body.

Moreover, in various imaging device usage conditions under which, for example, the accessory is replaced with a new accessory or is attached to or detached from the device main body in a state in which the device main body is set on a tripod or the accessory is replaced with a new accessory or is attached to or detached from the device main body with one hand, when a method for attaching the accessory to the device main body is fixed, it also may be difficult to attach or detach the accessory to or from the device main body, for example.

It is desirable to provide an accessory and an imaging device that make it easier to attach or detach the accessory to or from a device main body.

Firstly, according to an embodiment of the present technology, there is provided an accessory including a connecting section which is connected to a mount section provided in a device main body, an operating lever operated and moved in a predetermined direction, and a body supporting the operating lever. A bayonet connection method by which the accessory is properly positioned on the device main body and the whole of the accessory is rotated to connect the connecting section to the mount section and attach the accessory to the device main body or a spigot connection method by which the accessory is properly positioned on the device main body and the operating lever is operated to connect the connecting section to the mount section and attach the accessory to the device main body can be selected.

Therefore, in the accessory, the connecting section is connected to the mount section by the selected bayonet connection method or spigot connection method.

Secondly, in the accessory described above, it is preferable that a mark for properly positioning the accessory on the device main body be provided in the operating lever.

By providing a mark for properly positioning the accessory on the device main body in the operating lever, it is not necessary to provide a special portion for providing a mark in the accessory.

Thirdly, in the accessory described above, it is preferable that the connecting section be rotatably supported on the body, the operating lever and the connecting section can be rotated together, the operating lever and the connecting section be rotated together with the rotation of the body to connect the connecting section to the mount section by the bayonet connection method, and the operating lever and the connecting section be rotated together by the operation of the operating lever to connect the connecting section to the mount section by the spigot connection method.

The operating lever and the connecting section are rotated together with the rotation of the body to connect the connecting section to the mount section by the bayonet connection method, and the operating lever and the connecting section are rotated together by the operation of the operating lever to connect the connecting section to the mount section by the spigot connection method. As a result, in both methods of connection, the operating lever and the connecting section are rotated together to connect the connecting section to the mount section.

Fourthly, in the accessory described above, it is preferable that a regulated section regulating a position of the accessory with respect to the device main body by engaging a regulating section provided in the device main body be provided, and, when the connecting section is connected to the mount section and the accessory is attached to the device main body, the position of the accessory with respect to the device main body be regulated as a result of the regulated section engaging the regulating section.

When the connecting section is connected to the mount section and the accessory is attached to the device main body, the regulated section engages the regulating section, and the position of the accessory with respect to the device main body is regulated. As a result, the accessory is not moved with respect to the device main body in a state in which the accessory is attached to the device main body.

Fifthly, in the accessory described above, it is preferable that the operating lever can be operated between a locked position in which the operating lever is locked in the body and an unlocked position in which the operating lever is rotatable with respect to the body, and, in a state in which the operating lever is in the locked position, the connecting section be connected to the mount section and the accessory be attached to the device main body by the bayonet connection method.

In a state in which the operating lever is in the locked position, the connecting section is connected to the mount section and the accessory is attached to the device main body by the bayonet connection method. As a result, the operating lever is locked when the accessory is attached to the device main body.

Sixthly, in the accessory described above, it is preferable that the operating lever can be operated between a locked position in which the operating lever is locked in the body and an unlocked position in which the operating lever is rotatable with respect to the body, and the operating lever be operated and moved to the locked position and the connecting section be connected to the mount section and the accessory be attached to the device main body by the spigot connection method.

The operating lever is operated and moved to the locked position, and the connecting section is connected to the mount section and the accessory is attached to the device main body by the spigot connection method. As a result, the operating lever is locked when the accessory is attached to the device main body.

Seventhly, in the accessory described above, it is preferable that a click ball moved with the movement of the operating lever, a fixed section having a rolling contact surface on which the click ball is rolled, the fixed section having formed therein a fit recessed portion into which the click ball can be fitted, and a biasing spring pressing the click ball against the rolling contact surface be provided, and the click ball be fitted into the fit recessed portion when the operating lever is moved to the locked position.

When the operating lever is moved to the locked position, the click ball is fitted into the fit recessed portion. As a result, the movement produced when the operating lever is moved to the locked position and the operating lever is locked is transmitted to the user (the operator).

According to another embodiment of the present technology, there is provided an imaging device including a device main body in which a mount section is provided, and an accessory having a connecting section which is connected to the mount section, an operating lever operated and moved in a predetermined direction, and a body supporting the operating lever. A bayonet connection method by which the accessory is properly positioned on the device main body and the whole of the accessory is rotated to connect the connecting section to the mount section and attach the accessory to the device main body or a spigot connection method by which the accessory is properly positioned on the device main body and the operating lever is operated to connect the connecting section to the mount section and attach the accessory to the device main body can be selected.

Therefore, in the imaging device, the connecting section is connected to the mount section by the selected bayonet connection method or spigot connection method.

The accessory and the imaging device according to the embodiment of the present technology make it easier to attach or detach the accessory to or from the device main body.

### BRIEF DESCRIPTION OF THE DRAWINGS

FIG. 1 is a perspective view of an imaging device according to a preferred embodiment of the present technology along with FIGS. 2 to 36;

FIG. 2 is an exploded perspective view of the imaging device;

FIG. 3 is a front view of a device main body;

FIG. 4 is a perspective view of an adapter;

FIG. 5 is a rear view of the adapter;

FIG. 6 is an enlarged exploded perspective view showing an operating lever etc.;

FIG. 7 is a perspective view showing a fixed ring, a movable ring, and the operating lever;

FIG. 8 is an enlarged perspective view showing the operating lever etc.;

FIG. 9 is a schematic front view showing, along with FIGS. 10 to 12, the operation performed when the adapter is attached to or detached from the device main body by a bayonet connection method, the schematic front view showing a state of a locking piece etc., part thereof being shown in cross section, when the operating lever is in an unlocked position;

FIG. 10 is a schematic front view showing a state, part thereof being shown in cross section, in which the adapter is properly positioned on the device main body;

FIG. 11 is a schematic front view showing a state, part thereof being shown in cross section, in which the adapter is being rotated with respect to the device main body;

FIG. 12 is a schematic front view showing a state, part thereof being shown in cross section, in which the adapter is attached to the device main body;

FIG. 13 is a schematic front view showing, along with FIGS. 14 to 19, the operation performed when the adapter is attached to or detached from the device main body by a spigot connection method, the schematic front view showing a state of the locking piece etc., part thereof being shown in cross section, when the operating lever is in a locked position;

FIG. 14 is an enlarged sectional view showing a state in which part of a click ball is fitted into one fit recessed portion;

FIG. 15 is a schematic front view showing a state, part thereof being shown in cross section, in which the adapter is properly positioned on the device main body;

FIG. 16 is a schematic front view showing a state, part thereof being shown in cross section, in which the operating lever is being operated to the locked position;

FIG. 17 is an enlarged sectional view showing a state in which the click ball is slid on the fixed ring;

FIG. 18 is a schematic front view showing a state, part thereof being shown in cross section, in which the adapter is attached to the device main body;

FIG. 19 is an enlarged sectional view showing a state in which part of the click ball is fitted into the other fit recessed portion;

FIG. 20 is a schematic front view showing, along with FIGS. 21 to 24, the operation performed when the adapter is attached to the device main body in a state in which the operating lever is present between the locked position and the unlocked position, the schematic front view showing a state, part thereof being shown in cross section, in which the adapter is properly positioned on the device main body;

FIG. 21 is a schematic front view showing a state, part thereof being shown in cross section, in which the adapter is rotated with respect to the device main body;

FIG. 22 is a schematic front view showing a state, part thereof being shown in cross section, in which the operating lever is operated to the locked position and the adapter is attached to the device main body;

FIG. 23 is a schematic front view showing a state, part thereof being shown in cross section, in which the operating lever is operated to the locked position;

FIG. 24 is a schematic front view showing a state, part thereof being shown in cross section, in which the adapter is rotated with respect to the device main body and the adapter is attached to the device main body;

FIG. 25 is a perspective view showing a modified example of the adapter along with FIGS. 26 to 35;

FIG. 26 is a perspective view showing the fixed ring, the movable ring, and the operating lever;

FIG. 27 is an enlarged exploded perspective view showing the operating lever etc.;

FIG. 28 is an enlarged sectional view of an operated section in the operating lever;

FIG. 29 is a perspective view showing, along with FIGS. 30 to 35, the operation performed when the adapter is attached to or detached from the device main body by the spigot connection method, the perspective view showing the state of the adapter when the operating lever is in a first locked position;

FIG. 30 is a schematic enlarged sectional view showing a state in which an engagement section of a click member engages a second engagement groove;

FIG. 31 is a perspective view showing a state in which a turning operation section is drawn out of a first locking recessed portion when the operating lever is in the first locked position;

FIG. 32 is a schematic enlarged sectional view showing a state in which the engagement section of the click member engages a first engagement groove;

FIG. 33 is a perspective view showing a state in which the operating lever is being operated to a second locked position;

FIG. 34 is a perspective view showing a state in which the operating lever is operated to the second locked position, the state before the turning operation section is fitted into a second locking recessed portion;

FIG. 35 is a perspective view showing a state in which the turning operation section is fitted into the second locking recessed portion when the operating lever is operated to the second locked position; and

FIG. 36 is a block diagram of the imaging device.

### DETAILED DESCRIPTION OF EMBODIMENTS

Hereinafter, a preferred embodiment of the present technology will be described with reference to accompanying drawings.

An imaging device according to the following preferred embodiment of the present technology is applied to a still camera, and an accessory according to the following preferred embodiment of the present technology is applied to an accessory of the still camera.

Incidentally, the range of application of the embodiment of the present technology is not limited to the still camera and the accessory of the still camera. The embodiment of the present technology can be widely applied to, for example, various kinds of imaging devices other than the still camera, such as a video camera, and accessories of these imaging devices.

In the following description, a front-back direction, a vertical direction, and a horizontal direction are based on the position of a photographer when the photographer is taking a picture with the still camera. Therefore, the side where a subject is located is the front side and the side where the photographer is located is the back side.

Incidentally, the front-back direction, the vertical direction, and the horizontal direction in the following description are provided for convenience of description, and directions are not limited to these directions in implementing the embodiment of the present technology.

### Schematic Structure of Imaging Device

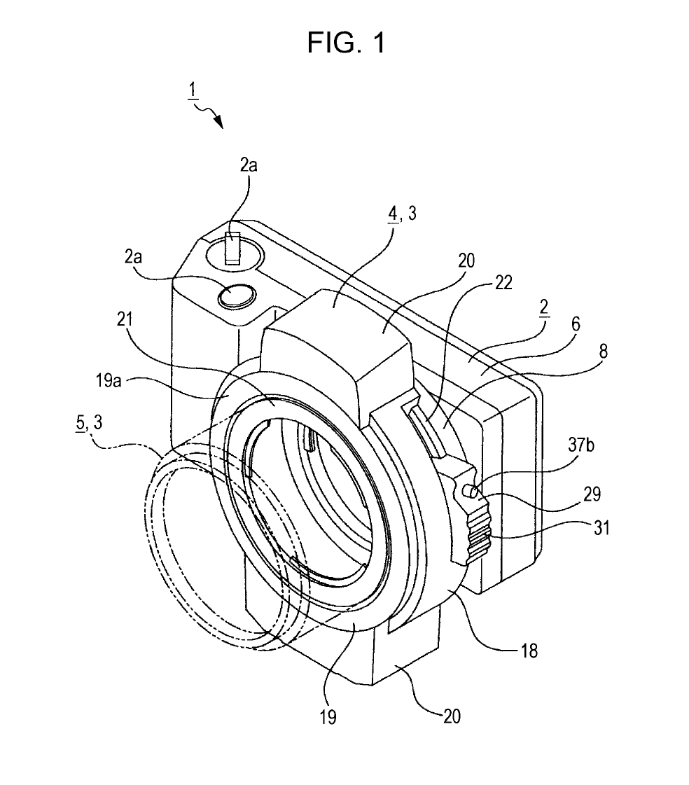

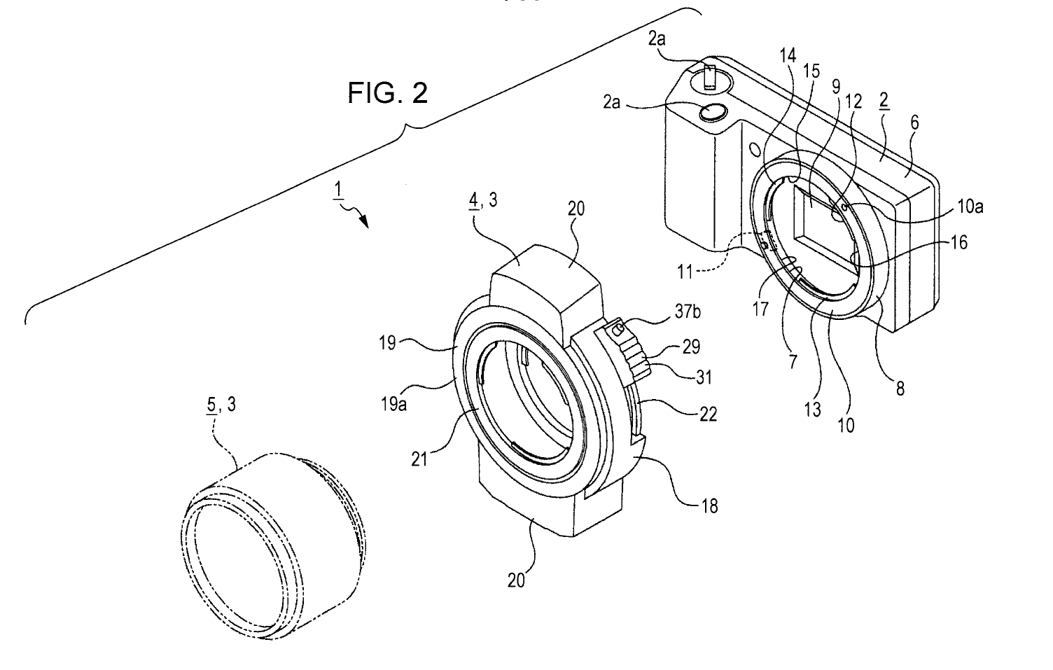

An imaging device 1 includes a device main body 2 and an accessory 3 (see FIGS. 1 and 2). As the accessory 3, for example, an adapter 4 and an interchangeable lens 5 are used. However, the accessory 3 may be formed only of the interchangeable lens 5.

That is, when the interchangeable lens 5 is attached to the device main body 2 via the adapter 4, both the adapter 4 and the interchangeable lens 5 are formed as the accessories 3 and 3. On the other hand, when the interchangeable lens 5 is attached to the device main body 2 without the adapter 4, only the interchangeable lens 5 is formed as the accessory 3.

Hereinafter, a case in which the interchangeable lens 5 is attached to the device main body 2 via the adapter 4 will be described. Therefore, both the adapter 4 and the interchangeable lens 5 are formed as the accessories 3 and 3.

### Structure of Device Main Body

The device main body 2 is formed of necessary sections disposed inside and outside a housing 6 (see FIGS. 1 and 2).

On a top face of the housing 6, various kinds of input operating sections 2a, 2a, . . . are disposed. As the input operating sections 2a, 2a, . . . , a power button, a shutter button, and a mode switching knob, for example, are provided.

On a rear face of the housing 6, unillustrated various kinds of input operating sections and a display are disposed. As the input operating sections, a zoom switch and a mode switching knob, for example, are provided.

A circular opening 7 is formed in the front face of the housing 6, and a portion surrounding the opening 7 is provided as an attaching section 8 to which the adapter 4 is attached.

In the housing 6, an image sensor 9 such as a CCD (charge coupled device) or a CMOS (complementary metal-oxide semiconductor) is disposed, and the image sensor 9 is located behind the opening 7.

In the housing 6, an unillustrated contact section is disposed behind the opening 7.

In the attaching section 8, a plate-like circular ring-shaped mount ring 10 facing in the front-back direction is provided, and the mount ring 10 functions as a mount section to which a movable ring 26, which will be described later, functioning as a connecting section of the adapter 4 is connected. In a position closer to the right edge of the mount ring 10, a projection placement hole penetrating the mount ring 10 in the front-back direction is formed.

In the mount ring 10, for example, in a position at the top end thereof closer to the left side, a positioning section 10a is provided. For example, the positioning section 10a is formed to have a circular shape, and a predetermined color such as white is given to the positioning section 10a to make the positioning section 10a more prominent than other portions.

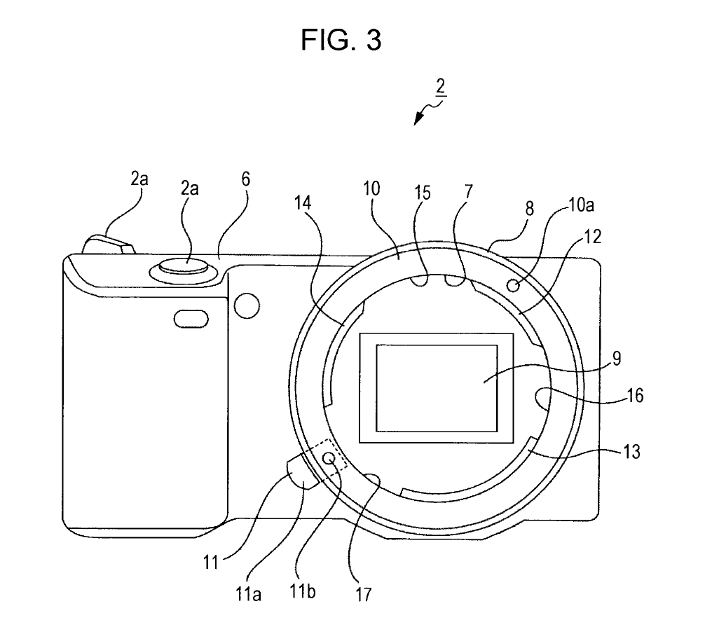

In the attaching section 8, a release button 11 is disposed (see FIG. 3). The release button 11 is movable in the front-back direction and has a pressing operation section 11a and a regulating projection 11b, which are moved together in the front-back direction. The release button 11 is biased forward by an unillustrated spring member, the pressing operation section 11a is placed outside the mount ring 10, and the tip of the regulating projection 11b juts forward from the projection placement hole of the mount ring 10 by the biasing force of the spring member.

The regulating projection 11b functions as a regulating section regulating the position of the adapter 4 with respect to the device main body 2 when the adapter 4 is attached to the device main body 2.

In the attaching section 8, engagement projections 12, 13, and 14 are provided at intervals in a circumferential direction on the inner circumferential side of the mount ring 10. The engagement projections 12, 13, and 14 are formed to have an arc shape along the mount ring 10 and have different lengths in an arc direction. Behind the engagement projections 12, 13, and 14, space is formed, and portions (space) between the engagement projections 12, 13, and 14 are formed as insertion sections 15, 16, and 17. The lengths of the insertion sections 15, 16, and 17 in a circumferential direction are different from one another.

### Structure of Adapter

The adapter 4 is formed of necessary sections disposed inside and outside a body 18 (see FIGS. 1, 2, 4, and 5).

The body 18 is formed of an attached section 19 formed to have a substantially cylindrical shape whose axial direction coincides with the front-back direction and projections 20 and 20 projecting from the attached section 19 in upper and lower portions thereof. Unillustrated functional sections having predetermined functions, such as an auto focus sensor, are built into the projections 20 and 20.

To a front face 19a of the attached section 19, a plate-like circular ring-shaped connection ring 21 facing in the front-back direction is attached (see FIGS. 1 and 2). To the connection ring 21, the interchangeable lens 5 is connected. The interchangeable lens 5 is attached to the adapter 4 by a bayonet connection method by which the whole of the interchangeable lens 5 is rotated with respect to the adapter 4 or by a spigot connection method by which an unillustrated lever is operated. In the front face of the attached section 19, an unillustrated lock mechanism is provided, and the interchangeable lens 5 is attached in a state in which the interchangeable lens 5 is locked in the connection ring 21 of the adapter 4 by the lock mechanism.

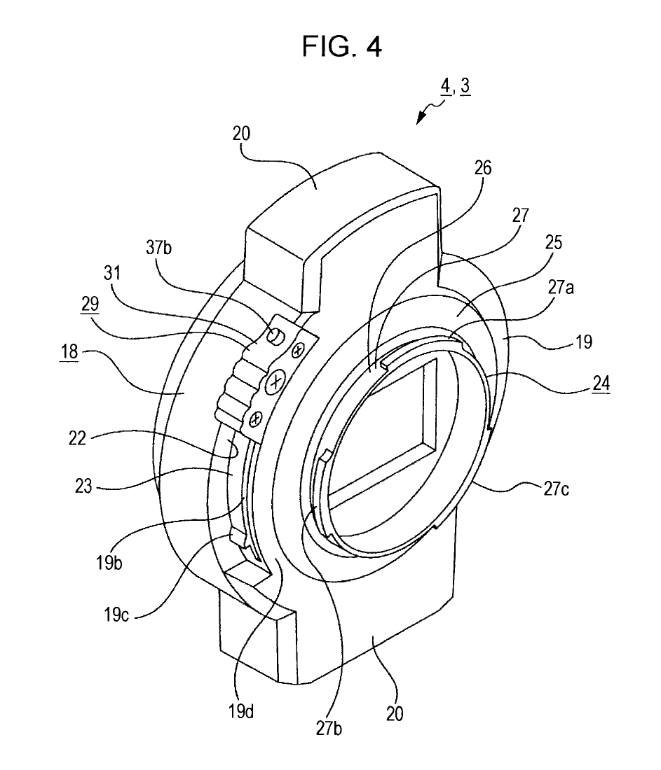

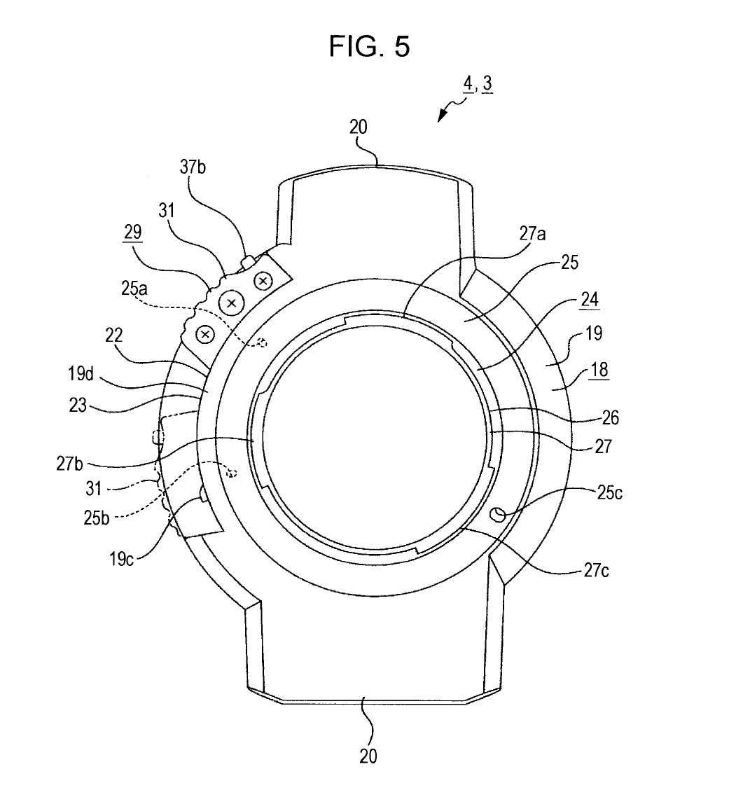

In the attached section 19, a movement slit 22 formed in a side (a left side) of the attached section 19 in a rearward position and extending in a circumferential direction is formed (see FIGS. 4 and 5). In the attached section 19, an insertion slit 19b making the movement slit 22 communicate with the inside is formed. The insertion slit 19b is formed in a bottom face 23 in such a way as to extend in a circumferential direction, the bottom face 23 forming the movement slit 22 and facing outward.

In the attached section 19, a lock projection 19c jutting outward from the bottom face 23 of the movement slit 22 is provided, and the lock projection 19c is located on the front side in a lower end portion of the insertion slit 19b.

In a position closer to the lower edge of the attached section 19 of the body 18, an unillustrated connection is disposed.

In a rear face 19d of the attached section 19, a detachable/attachable section 24 is provided. The detachable/attachable section 24 has a fixed ring 25 and a movable ring 26.

The fixed ring 25 is formed as a plate-like circular ring facing in the front-back direction and is fixed to the body 18.

In the fixed ring 25, fit recessed portions 25a and 25b formed on the front side in a left edge portion are formed at intervals in a circumferential direction, and a rotation regulating hole 25c is formed in a right edge portion (see FIGS. 4 to 6). The rotation regulating hole 25c functions as a regulated section regulating the position of the adapter 4 with respect to the device main body 2 when the adapter 4 is attached to the device main body 2.

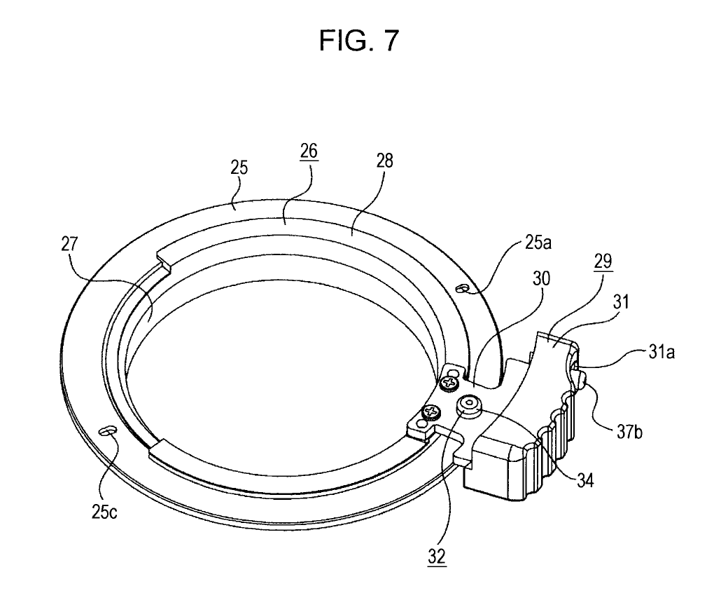

The movable ring 26 is formed of a substantially cylindrical ring section 27 and a connecting face portion 28 overhanging from a portion of the ring section 27, except for one part, at a front edge thereof (see FIG. 7). The movable ring 26 functions as a connecting section that is connected to the mount ring 10 of the device main body 2.

The ring section 27 is formed to be short in an axial direction and has engagement sections 27a, 27b, and 27c overhanging from a rear end portion thereof (see FIGS. 4 and 5). The engagement sections 27a, 27b, and 27c are formed to have an arc shape, and the lengths thereof in a circumferential direction are slightly shorter than the lengths of the insertion sections 15, 16, and 17, respectively, in a circumferential direction, the insertion sections 15, 16, and 17 formed between the engagement projections 12, 13, and 14 of the mount ring 10 in the device main body 2. The movable ring 26 can rotate with respect to the fixed ring 25 in a state in which the ring section 27 juts rearward from the inner opening edge of the fixed ring 25 and the connecting face portion 28 faces the front face of the fixed ring 25.

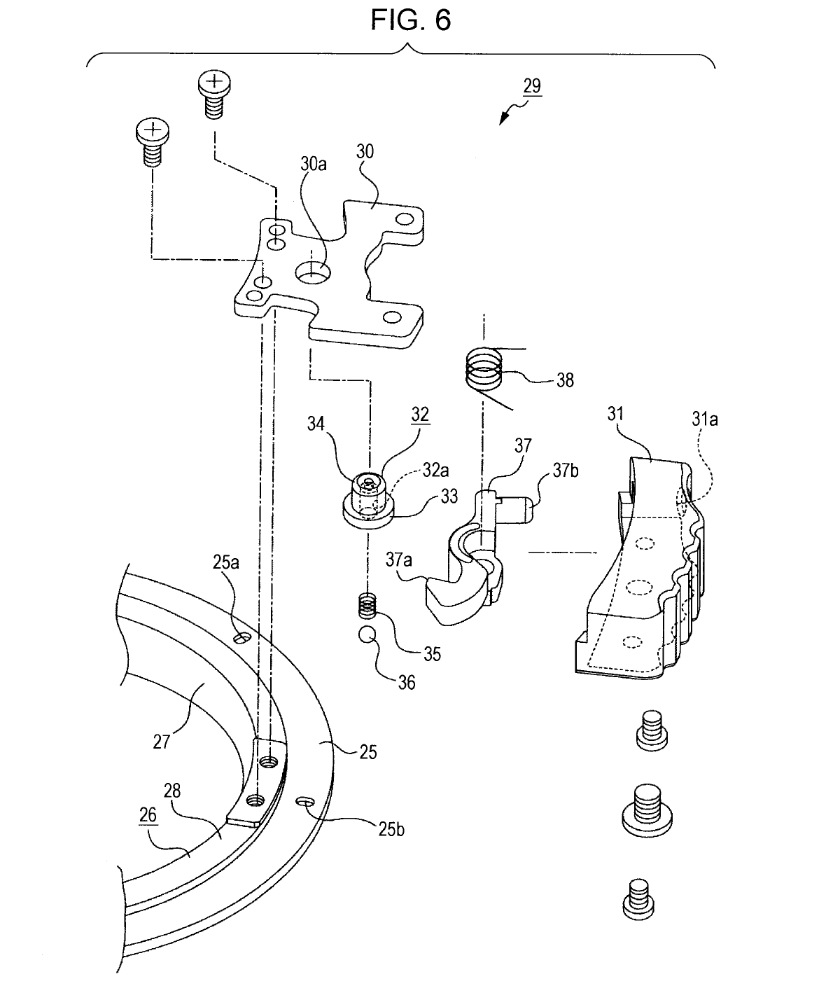

To the front face of the connecting face portion 28 in the movable ring 26, an operating lever 29 is connected with a screw or the like (see FIGS. 6 to 8).

The operating lever 29 has a connecting arm 30 and an operated section 31 attached to one end of the connecting arm 30.

The connecting arm 30 has a middle portion placed through the insertion slit 19b formed in the attached section 19 of the body 18, an inner end attached to the connecting face portion 28 with a screw or the like, and an outer end placed in the movement slit 22 of the attached section 19.

In the middle portion of the connecting arm 30, a placement hole 30a vertically penetrating the connecting arm 30 is formed, and a spring case 32 is inserted into the placement hole 30a and placed therethrough.

The spring case 32 is formed of a disk-shaped base section 33 facing in the front-back direction and an insertion shaft section 34 jutting rearward from the base section 33 (see FIG. 6).

In the spring case 32, a spring support hole 32a having an opening in the rear face of the base section 33 is formed, and a biasing spring 35 which is a compression coil spring is placed in the spring support hole 32a.

The base section 33 and the insertion shaft section 34 are placed on the same axis, and the outside diameter of the insertion shaft section 34 is made smaller than the outside diameter of the base section 33.

The insertion shaft section 34 of the spring case 32 is inserted into the placement hole 30a of the connecting arm 30 from behind. In a state in which the insertion shaft section 34 is inserted in the placement hole 30a, a click ball 36 is supported at the rear end of the biasing spring 35, and the biasing force of the biasing spring 35 is applied to the click ball 36. Therefore, the click ball 36 is pressed against the front face of the fixed ring 25 by the biasing force of the biasing spring 35.

The operated section 31 is formed as a box having an opening in an inward (right-hand) part thereof and is placed in the movement slit 22 by being attached to the outside end of the connecting arm 30 with a screw or the like. In a top end of the operated section 31, a pin insertion hole 31a penetrating the operated section 31 substantially from side to side is formed.

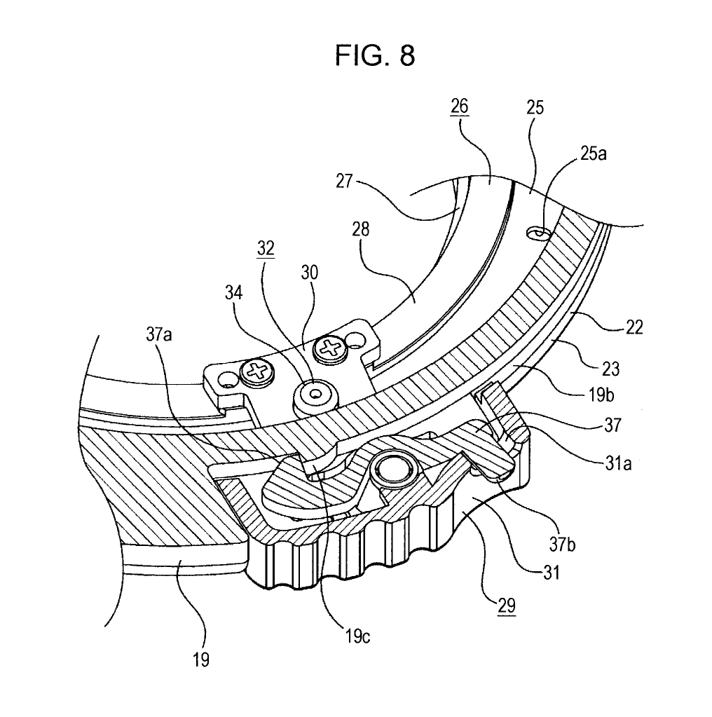

A locking piece 37 is turnably supported on the operated section 31 (see FIGS. 6 and 8). The locking piece 37 has a turning support shaft extending in a front-back direction, is formed into a shape extending in a substantially vertical direction, has, at a lower end thereof, a locking engagement section 37a jutting inward, and has, at an upper end thereof, an operating pin 37b jutting outward. The locking piece 37, except for the operating pin 37b, is placed in the operated section 31, and the operating pin 37b is placed through the pin insertion hole 31a and the tip thereof juts outward from the operated section 31.

A predetermined color such as white is given to the operating pin 37b to make the operating pin 37b more prominent than other portions. As described above, the operating pin 37b is made to be more prominent than other portions and functions as a mark allowing the operating pin 37b to be properly positioned at the positioning section 10a of the mount ring 10 when the adapter 4 is attached to the device main body 2.

In the operated section 31, a torsion coil spring 38 is disposed, and the locking piece 37 is biased in a direction in which the locking engagement section 37a moves closer to the bottom face 23 of the movement slit 22. Therefore, the locking engagement section 37a of the locking piece 37 is pressed against the bottom face 23 of the movement slit 22 by the biasing force of the torsion coil spring 38.

The operated section 31 of the operating lever 29 is movable in the movement slit 22 and is moved between an unlocked position which is an upper movement end and a locked position which is a lower movement end. The movable ring 26 is rotated with the movement of the operating lever 29.

In the interchangeable lens 5, an unillustrated lens group and an unillustrated drive mechanism that moves the lens group in the direction of an optical axis are disposed. The drive mechanism is operated by an instruction from an unillustrated control section disposed in the device main body 2 in a state in which communication between the interchangeable lens 5 and the device main body 2 is possible.

Operation Performed when Adapter is Attached to or Detached from Device Main Body

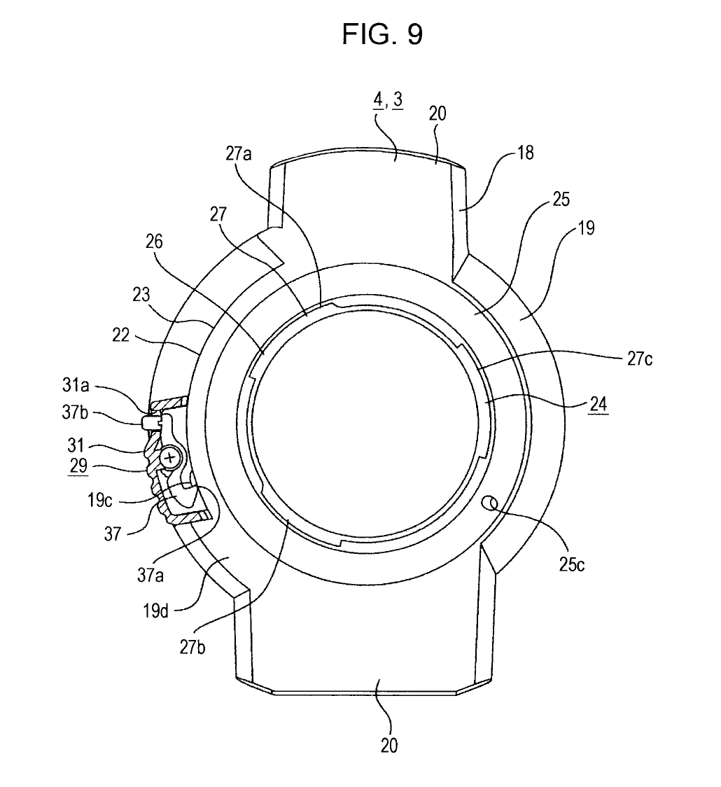

Hereinafter, the operation performed when the adapter 4 is attached to or detached from the device main body 2 will be described (see FIGS. 9 to 16). When the adapter 4 is attached to or detached from the device main body 2, the bayonet connection method by which the adapter 4 is properly positioned on the device main body 2 and the whole of the adapter 4 is rotated or the spigot connection method by which the adapter 4 is properly positioned on the device main body 2 and the operating lever 29 is operated can be selected.

First, attachment/detachment by the bayonet connection method will be described (see FIGS. 9 to 12).

When the adapter 4 is attached to the device main body 2 by the bayonet connection method, first, the operating lever 29 is kept in the locked position which is a lower movement end (see FIG. 9). At this time, the locking engagement section 37a of the locking piece 37 engages the lock projection 19c of the attached section 19, regulating the movement of the operating lever 29 with respect to the body 18. Moreover, when the operating lever 29 is in the locked position, part of the click ball 36 is inserted into the fit recessed portion 25b of the fixed ring 25 by the biasing force of the biasing spring 35.

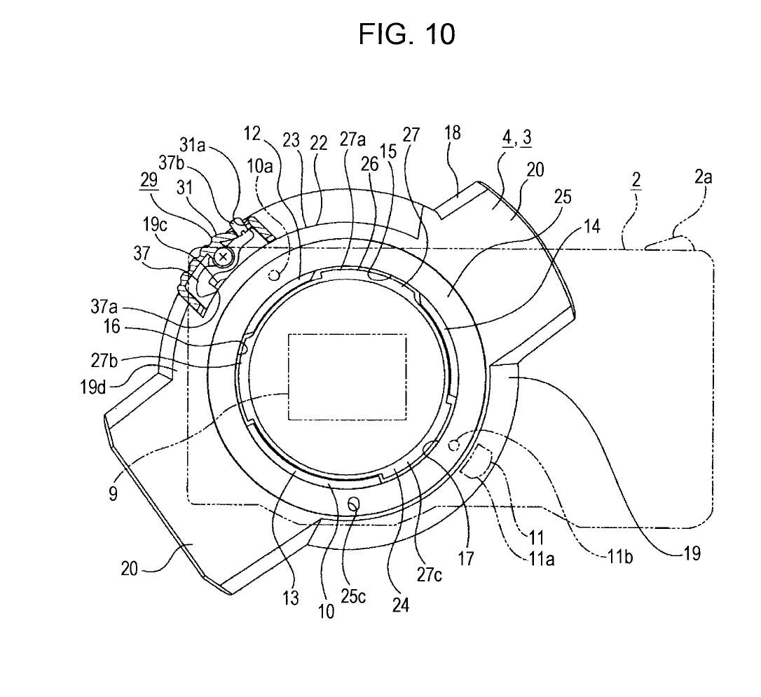

Next, the operating pin 37b of the locking piece 37 in the adapter 4, the operating pin 37b functioning as a mark, is placed directly in front of the positioning section 10a of the mount ring 10 in the device main body 2, and the adapter 4 is properly positioned on the device main body 2 (see FIG. 10).

In a state in which, as described above, the operating pin 37b functioning as a mark is placed directly in front of the positioning section 10a and the adapter 4 is properly positioned on the device main body 2, the engagement sections 27a, 27b, and 27c in the ring section 27 of the movable ring 26 are placed in such a way as to face the insertion sections 15, 16, and 17, respectively, formed between the engagement projections 12, 13, and 14.

The operating pin 37b functioning as a mark is provided in the operating lever 29. This makes it unnecessary to provide a special portion for providing a mark in the adapter 4 and makes it possible to position the adapter 4 properly on the device main body 2 reliably while reducing the number of parts and simplifying the mechanism.

Then, the engagement sections 27a, 27b, and 27c of the movable ring 26 are inserted into the insertion sections 15, 16, and 17, respectively, and the fixed ring 25 is pressed against the mount ring 10 of the device main body 2 from the front. At this time, as described earlier, the lengths of the engagement sections 27a, 27b, and 27c are different from the lengths of the insertion sections 15, 16, and 17, respectively. Therefore, since the adapter 4 is not attached to the device main body 2 in a direction other than the direction in which the engagement sections 27a, 27b, and 27c are placed in the insertion sections 15, 16, and 17, respectively, the adapter 4 is prevented from being attached to the device main body 2 in a wrong direction.

When the fixed ring 25 of the adapter 4 is pressed against the mount ring 10 of the device main body 2 from the front, the regulating projection 11b of the release button 11 is pressed against the fixed ring 25 from the front, moved backward against the biasing force of the spring member, and placed in the projection placement hole formed in the mount ring 10.

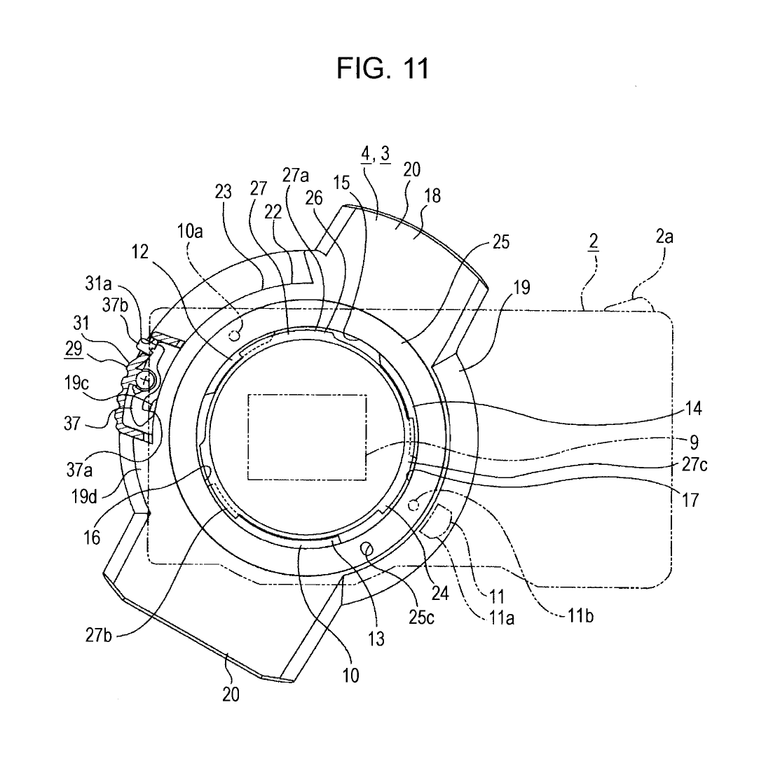

Next, the whole of the adapter 4 is rotated with respect to the device main body 2 (see FIG. 11). When the adapter 4 is rotated with respect to the device main body 2, the engagement sections 27a, 27b, and 27c of the movable ring 26 are inserted into the space behind the engagement projections 12, 13, and 14, respectively.

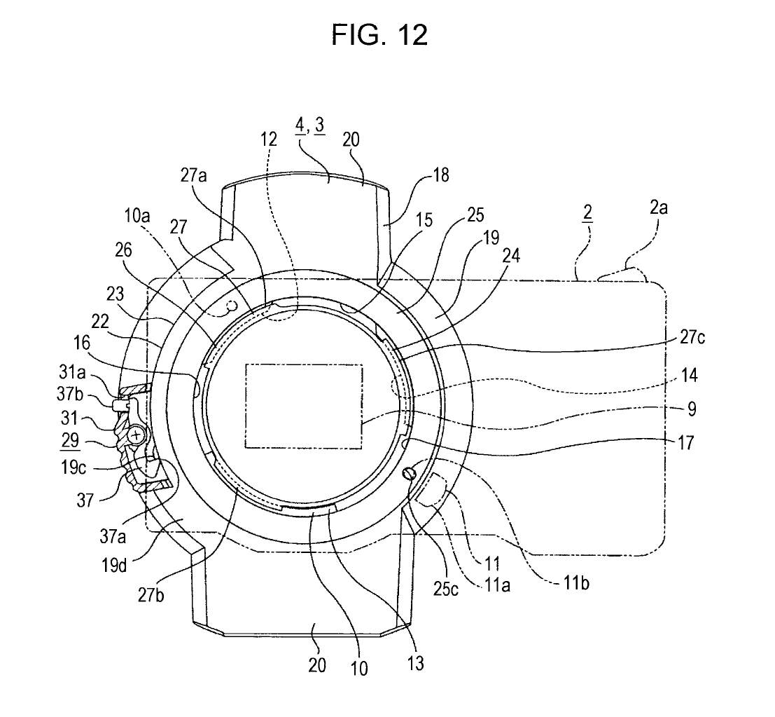

When the adapter 4 is continuously rotated with respect to the device main body 2, the engagement sections 27a, 27b, and 27c of the movable ring 26 are entirely inserted into the space behind the engagement projections 12, 13, and 14, respectively, and engage the engagement projections 12, 13, and 14, respectively (see FIG. 12). As soon as the engagement sections 27a, 27b, and 27c entirely engage the engagement projections 12, 13, and 14, respectively, the rotation regulating hole 25c of the fixed ring 25 coincides with the regulating projection 11b of the release button 11, and the regulating projection 11b is inserted into the rotation regulating hole 25c.

Therefore, the rotation of the adapter 4 with respect to the device main body 2 is regulated, and a state in which the engagement sections 27a, 27b, and 27c engage the engagement projections 12, 13, and 14, respectively, is maintained. In this way, the adapter 4 is locked in the device main body 2.

In a state in which the adapter 4 is locked in the device main body 2, the connection of the adapter 4 is connected to the contact section of the device main body 2, allowing the device main body 2, the adapter 4, and the interchangeable lens 5 to perform communication with one another.

When the adapter 4 is detached from the device main body 2, first, the pressing operation section 11a of the release button 11 in the device main body 2 is depressed. When the pressing operation section 11a is depressed, the regulating projection 11b is drawn out of the rotation regulating hole 25c and the adapter 4 is released from the device main body 2 in which the adapter 4 was locked.

Next, in a state in which the adapter 4 is released from the device main body 2 in which the adapter 4 was locked, the adapter 4 is rotated in a direction opposite to the direction in which the adapter 4 is rotated when the adapter 4 is attached to the device main body 2. When the adapter 4 is rotated with respect to the device main body 2, the engagement sections 27a, 27b, and 27c of the movable ring 26 are removed from engagement with the engagement projections 12, 13, and 14.

Then, the adapter 4 is drawn forward out of the device main body 2. In this way, the adapter 4 is detached from the device main body 2.

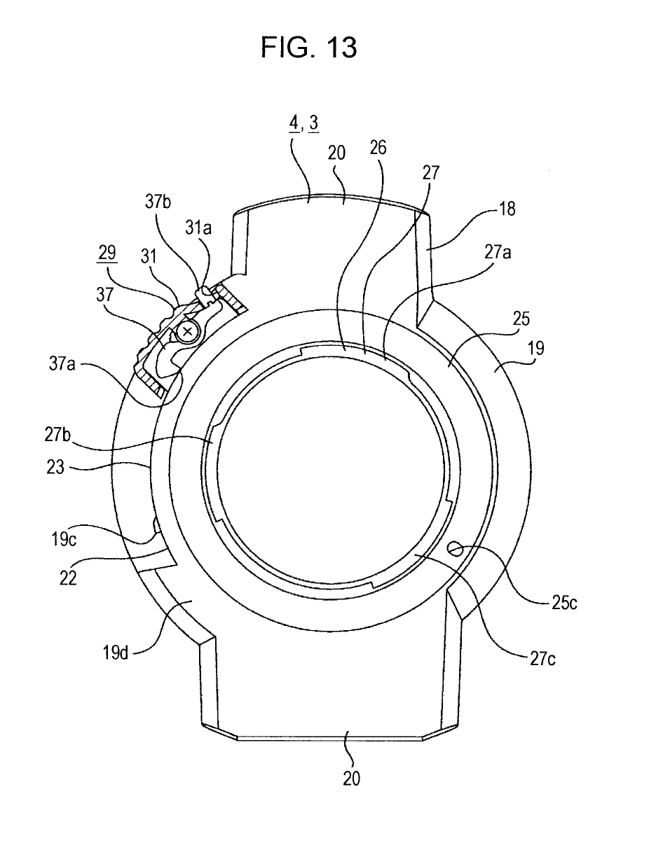

Next, attachment/detachment by the spigot connection method will be described (see FIGS. 13 to 19).

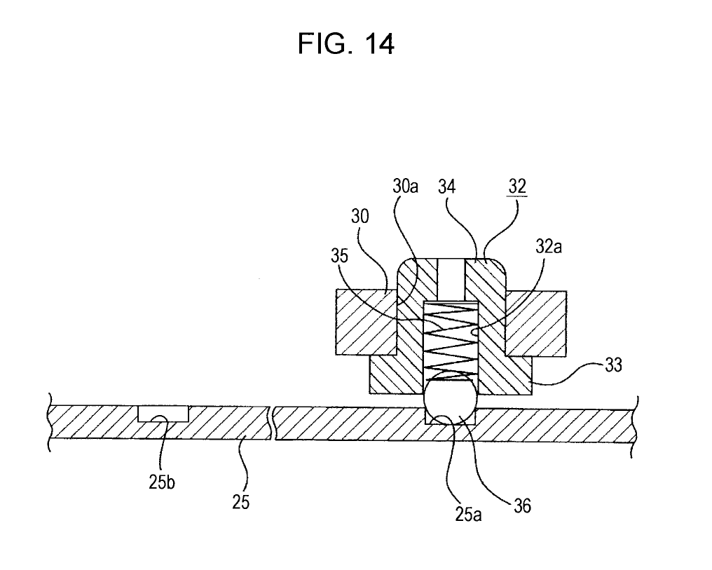

When the adapter 4 is attached to the device main body 2 by the spigot connection method, first, the adapter 4 is put into a state in which the adapter 4 is in the unlocked position (see FIG. 13). In a state in which the adapter 4 is in the unlocked position, part of the click ball 36 is inserted in the fit recessed portion 25a formed in the fixed ring 25 by the biasing force of the biasing spring 35 (see FIG. 14).

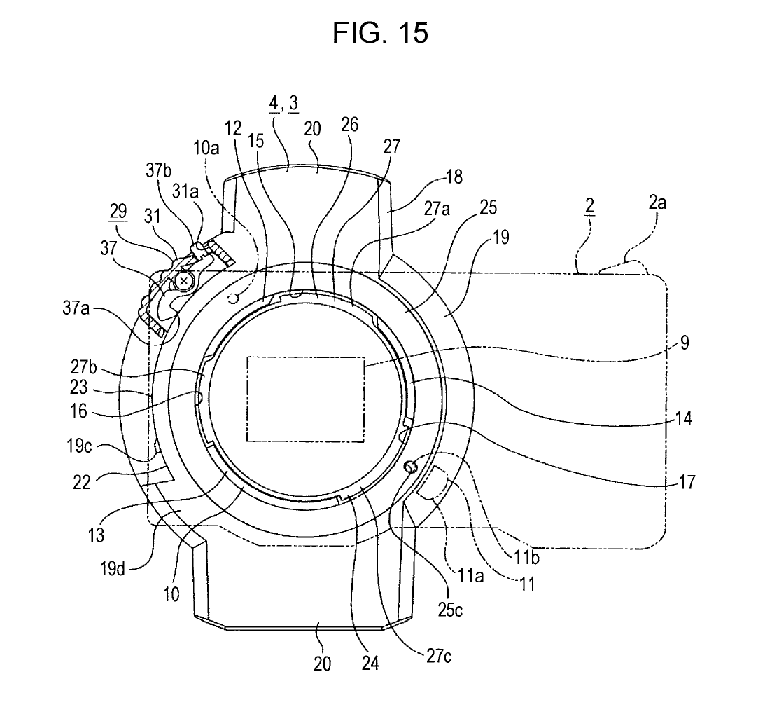

Next, the operating pin 37b of the locking piece 37 in the adapter 4, the operating pin 37b functioning as a mark, is placed directly in front of the positioning section 10a of the mount ring 10 in the device main body 2, and the adapter 4 is properly positioned on the device main body 2 (see FIG. 15).

In a state in which the operating pin 37b functioning as a mark is placed directly in front of the positioning section 10a and the adapter 4 is properly positioned on the device main body 2 as described above, the engagement sections 27a, 27b, and 27c in the ring section 27 of the movable ring 26 are placed in such a way as to face the insertion sections 15, 16, and 17, respectively, formed between the engagement projections 12, 13, and 14.

The operating pin 37b functioning as a mark is provided in the operating lever 29. This makes it unnecessary to provide a special portion for providing a mark in the adapter 4 and makes it possible to position the adapter 4 properly on the device main body 2 reliably while reducing the number of parts and simplifying the mechanism.

Next, the engagement sections 27a, 27b, and 27c of the movable ring 26 are inserted into the insertion sections 15, 16, and 17, respectively, and the fixed ring 25 is pressed against the mount ring 10 of the device main body 2 from the front. At this time, as described earlier, the lengths of the engagement sections 27a, 27b, and 27c are different from the lengths of the insertion sections 15, 16, and 17. Therefore, since the adapter 4 is not attached to the device main body 2 in a direction other than the direction in which the engagement sections 27a, 27b, and 27c are placed in the insertion sections 15, 16, and 17, respectively, the adapter 4 is prevented from being attached to the device main body 2 in a wrong direction.

When the fixed ring 25 of the adapter 4 is pressed against the mount ring 10 of the device main body 2 from the front, the regulating projection 11b of the release button 11 is inserted into the rotation regulating hole 25c of the fixed ring 25, and the rotation of the adapter 4 with respect to the device main body 2 is regulated.

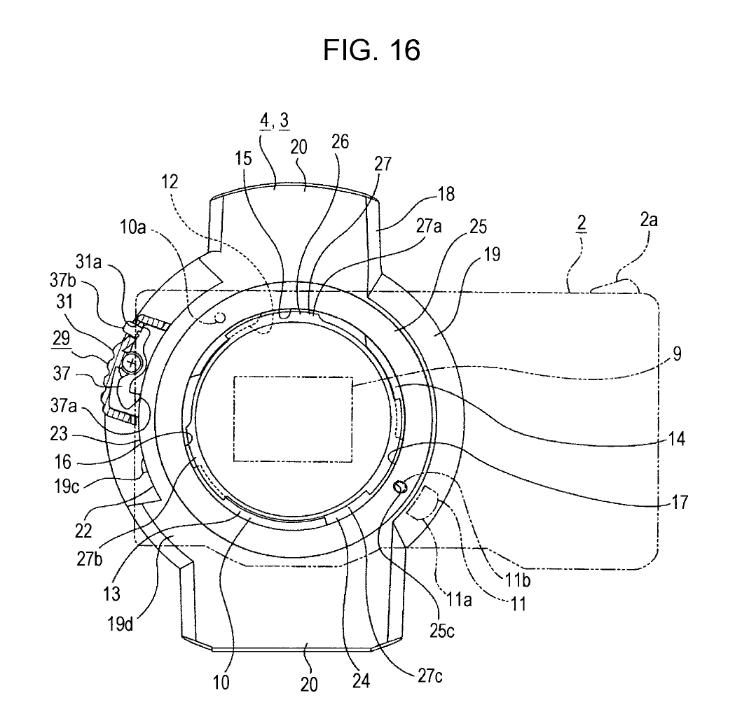

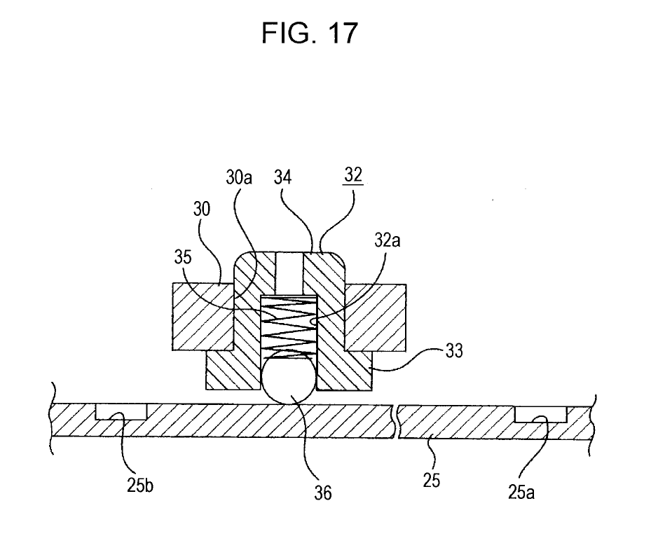

Next, the operating lever 29 is operated from the unlocked position to the locked position (see FIG. 16). When the operating lever 29 is operated to the locked position, the movable ring 26 rotates with the operating lever 29, and the engagement sections 27a, 27b, and 27c of the movable ring 26 are inserted into the space behind the engagement projections 12, 13, and 14, respectively. At this time, the locking engagement section 37a of the locking piece 37 is slid on the bottom face 23 of the movement slit 22, and the click ball 36 is slid on the front face of the fixed ring 25 (see FIG. 17).

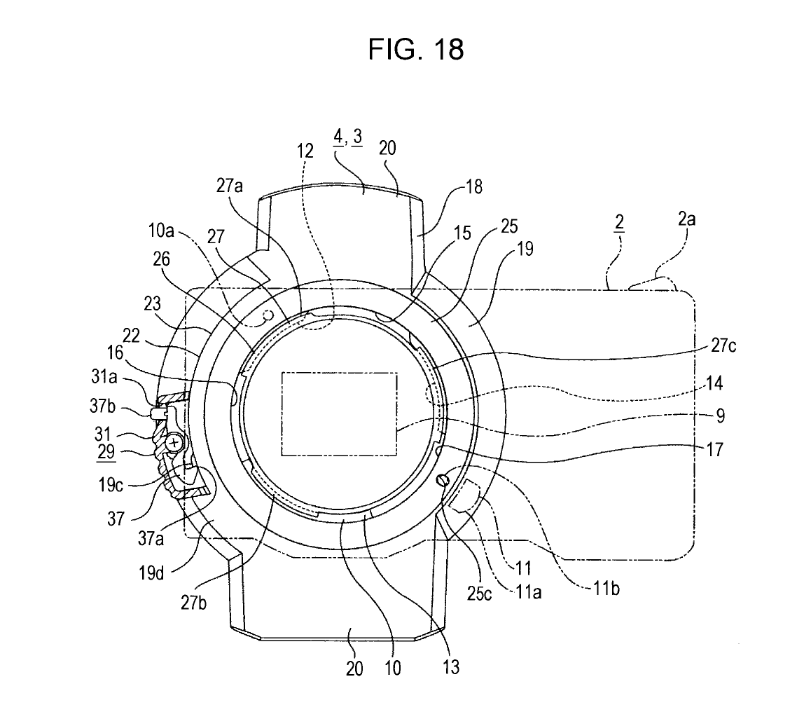

When the operating lever 29 is continuously operated and moved to the locked position, the engagement sections 27a, 27b, and 27c of the movable ring 26 are entirely inserted into the space behind the engagement projections 12, 13, and 14, respectively, and engage the engagement projections 12, 13, and 14, respectively (see FIG. 18).

When the operating lever 29 is moved to the locked position, the locking engagement section 37a of the locking piece 37 is slid on the lock projection 19c, temporarily turned against the biasing force of the torsion coil spring 38 and then turned again by the biasing force of the torsion coil spring 38, and engages the lock projection 19c. Therefore, the rotation of the movable ring 26 is regulated, a state in which the engagement sections 27a, 27b, and 27c engage the engagement projections 12, 13, and 14, respectively, is maintained, and the adapter 4 is locked in the device main body 2.

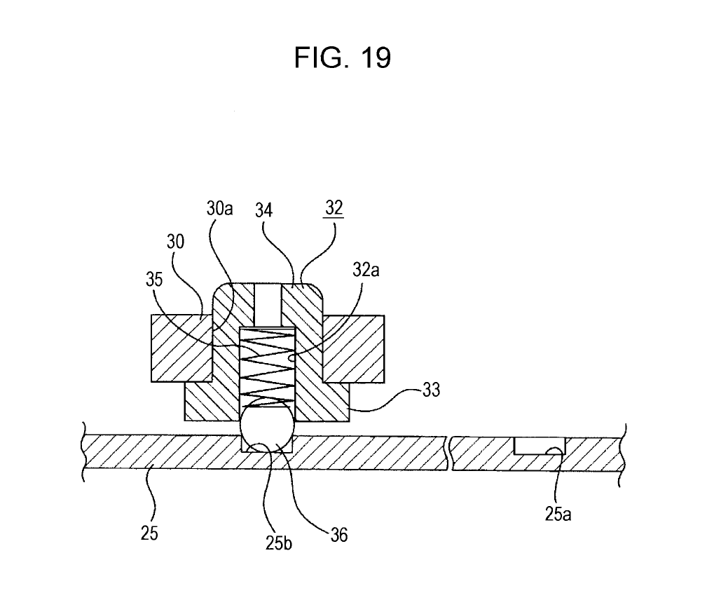

As soon as the operating lever 29 is moved to the locked position, the click ball 36 is moved to a position above the fit recessed portion 25b of the fixed ring 25, and part of the click ball 36 is inserted into the fit recessed portion 25b by the biasing force of the biasing spring 35 (see FIG. 19). Therefore, the movement produced when the operating lever 29 is moved to the locked position and the operating lever 29 is locked is transmitted to the user (the operator) as a so-called feeling of having made a click.

As a result of part of the click ball 36 being inserted into the fit recessed portion 25b as described above, the movement produced when the operating lever 29 is moved to the locked position and the operating lever 29 is locked is transmitted to the user. This makes it possible to enhance usability.

In a state in which the adapter 4 is locked in the device main body 2, the connection of the adapter 4 is connected to the contact section of the device main body 2, allowing the device main body 2, the adapter 4, and the interchangeable lens 5 to perform communication with one another.

When the adapter 4 is detached from the device main body 2, first, the operating pin 37b of the locking piece 37 is depressed. When the operating pin 37b of the locking piece 37 is depressed, the locking piece 37 is turned against the biasing force of the torsion coil spring 38, the locking engagement section 37a is removed from engagement with the lock projection 19c, and the adapter 4 is released from the device main body 2 in which the adapter 4 was locked.

Next, in a state in which the adapter 4 is released from the device main body 2 in which the adapter 4 was locked, the operating lever 29 is operated and moved from the locked position to the unlocked position. When the operating lever 29 is moved to the unlocked position, the engagement sections 27a, 27b, and 27c of the movable ring 26 are removed from engagement with the engagement projections 12, 13, and 14.

As soon as the operating lever 29 is moved to the unlocked position, the click ball 36 is moved to a position above the fit recessed portion 25a of the fixed ring 25, and part of the click ball 36 is inserted into the fit recessed portion 25a by the biasing force of the biasing spring 35. Therefore, the movement produced when the operating lever 29 is moved to the unlocked position is transmitted to the user (the operator) as a so-called feeling of having made a click.

Then, the adapter 4 is drawn forward out of the device main body 2. In this way, the adapter 4 is detached from the device main body 2.

As described above, in the imaging device 1, attachment of the adapter 4 to the device main body 2 by the bayonet connection method is started in a state in which the operating lever 29 is kept in the locked position, and attachment of the adapter 4 to the device main body 2 by the spigot connection method is started in a state in which the operating lever 29 is kept in the unlocked position.

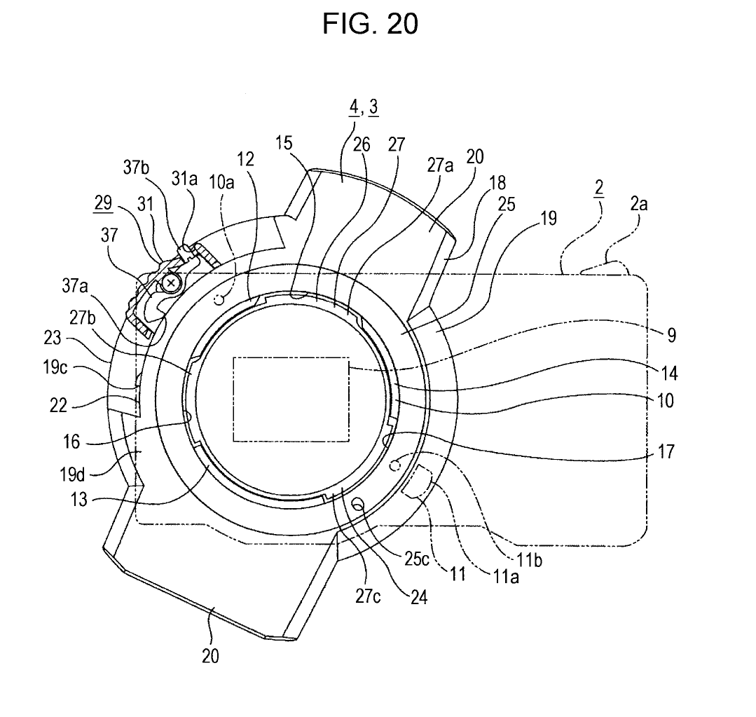

Therefore, attachment of the adapter 4 to the device main body 2 is started in a state in which the operating lever 29 is kept in the locked position or the unlocked position. However, the user may try to attach the adapter 4 to the device main body 2 by positioning the adapter 4 on the device main body 2 in a state in which the operating lever 29 is present between the locked position and the unlocked position (see FIG. 20).

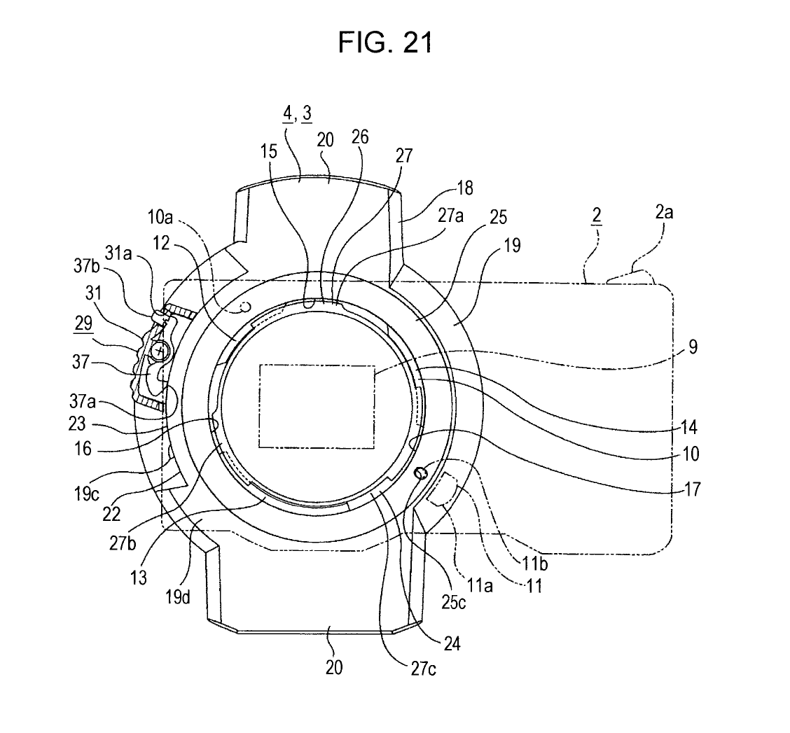

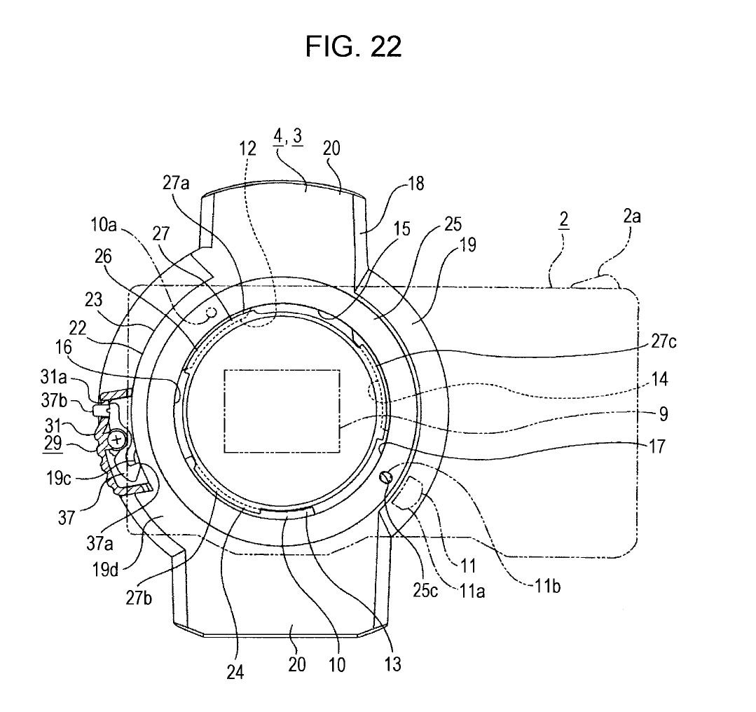

In such a case, first, in a state in which the engagement sections 27a, 27b, and 27c of the movable ring 26 are inserted in the insertion sections 15, 16, and 17, respectively, the adapter 4 is rotated with respect to the device main body 2 and the regulating projection 11b of the release button 11 is inserted into the rotation regulating hole 25c of the fixed ring 25 (see FIG. 21), and the operating lever 29 is then operated to the locked position (see FIG. 22). By doing so, it is possible to attach the adapter 4 to the device main body 2.

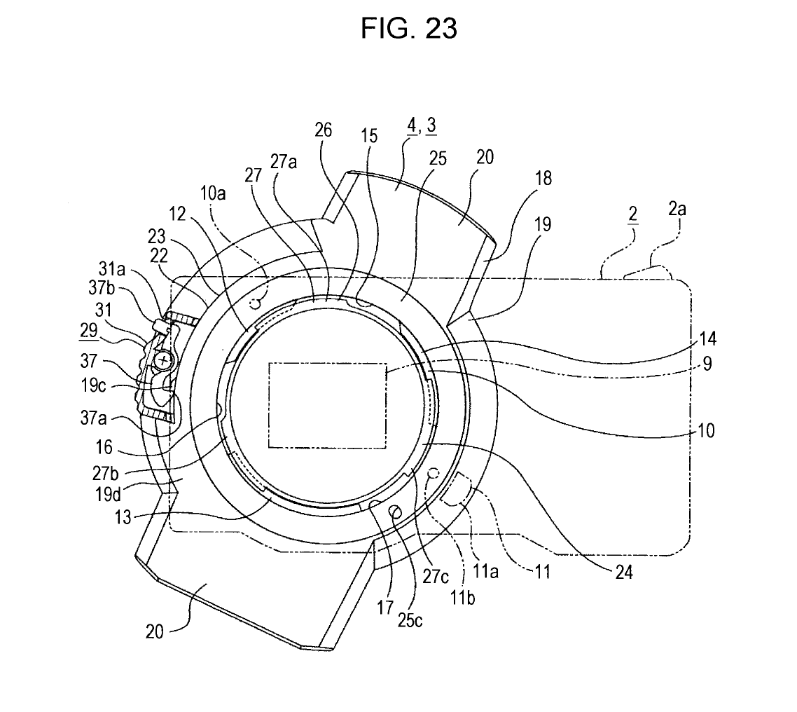

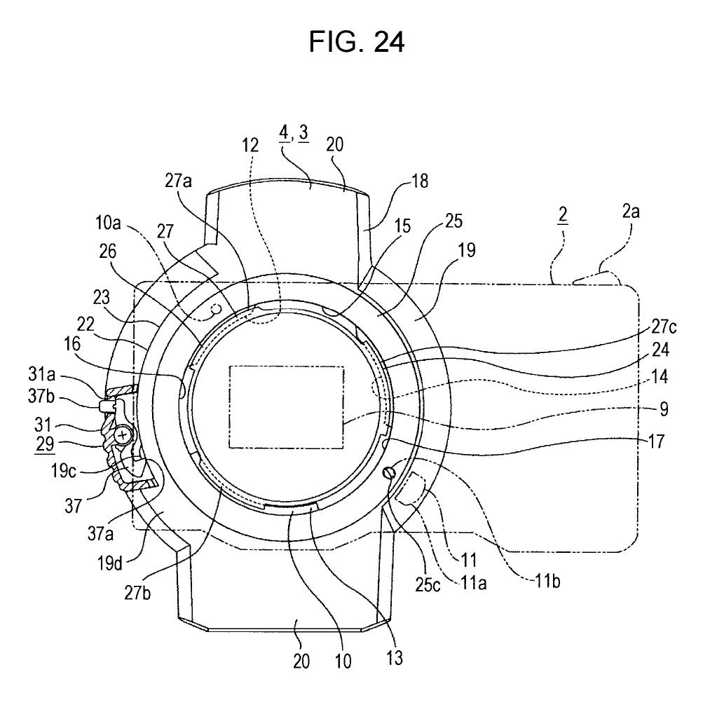

Moreover, in a state in which the engagement sections 27a, 27b, and 27c of the movable ring 26 are inserted in the insertion sections 15, 16, and 17, respectively, first, the operating lever 29 is operated to the locked position (see FIG. 23), the adapter 4 is then rotated with respect to the device main body 2, and the regulating projection 11b of the release button 11 is inserted into the rotation regulating hole 25c of the fixed ring 25 (see FIG. 24). By doing so, it is also possible to attach the adapter 4 to the device main body 2.

As described above, also in a state in which the user places the operating lever 29 between the locked position and the unlocked position, the adapter 4 can be attached to the device main body 2 by combination of the bayonet connection method and the spigot connection method. This makes it easier to attach the adapter 4 to the device main body 2.

### Modified Example

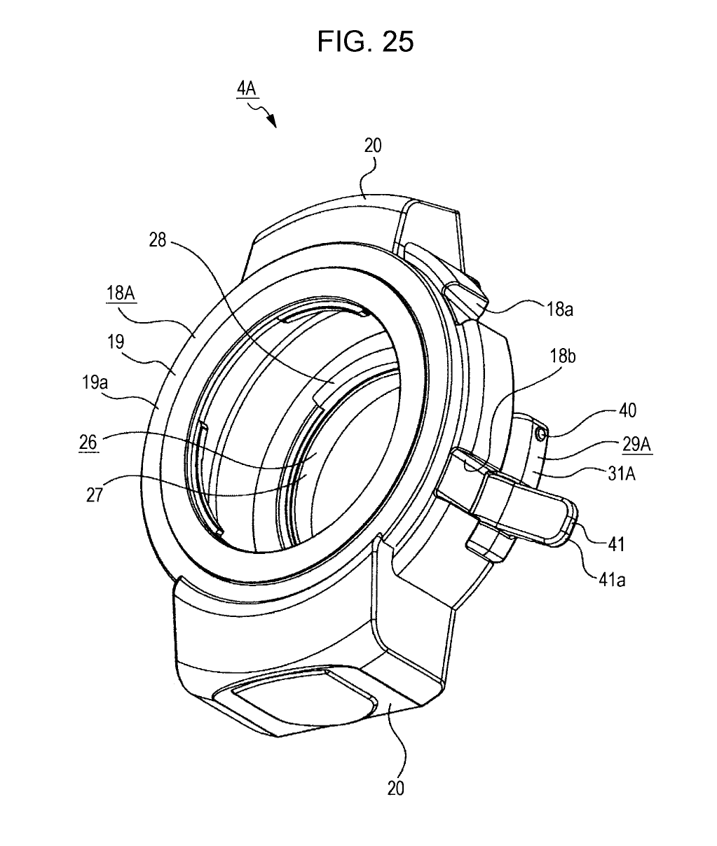

Hereinafter, a modified example of the adapter will be described (see FIGS. 25 to 35).

Incidentally, an adapter 4A according to the modified example described below differs from the adapter 4 described above only in the structure of the operating lever and in that two locking recessed portions are formed in the body. Therefore, only differences from the adapter 4 are described in detail, and other portions are identified with the same reference characters and overlapping descriptions will be omitted.

On the outer periphery of a body 18A in the adapter 4A, a first locking recessed portion 18a and a second locking recessed portion 18b which are formed as outward-facing openings are formed in different positions in a circumferential direction (see FIG. 25). The first locking recessed portion 18a and the second locking recessed portion 18b communicate with the movement slit 22.

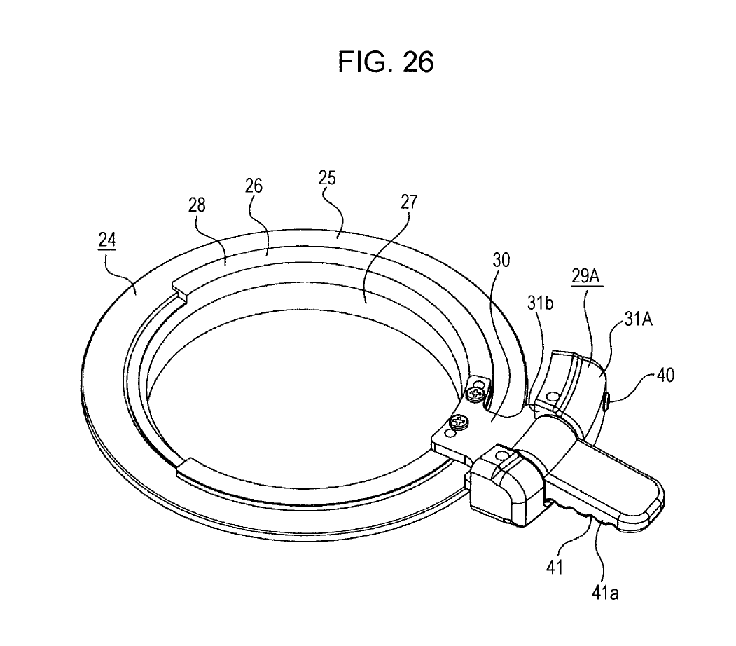

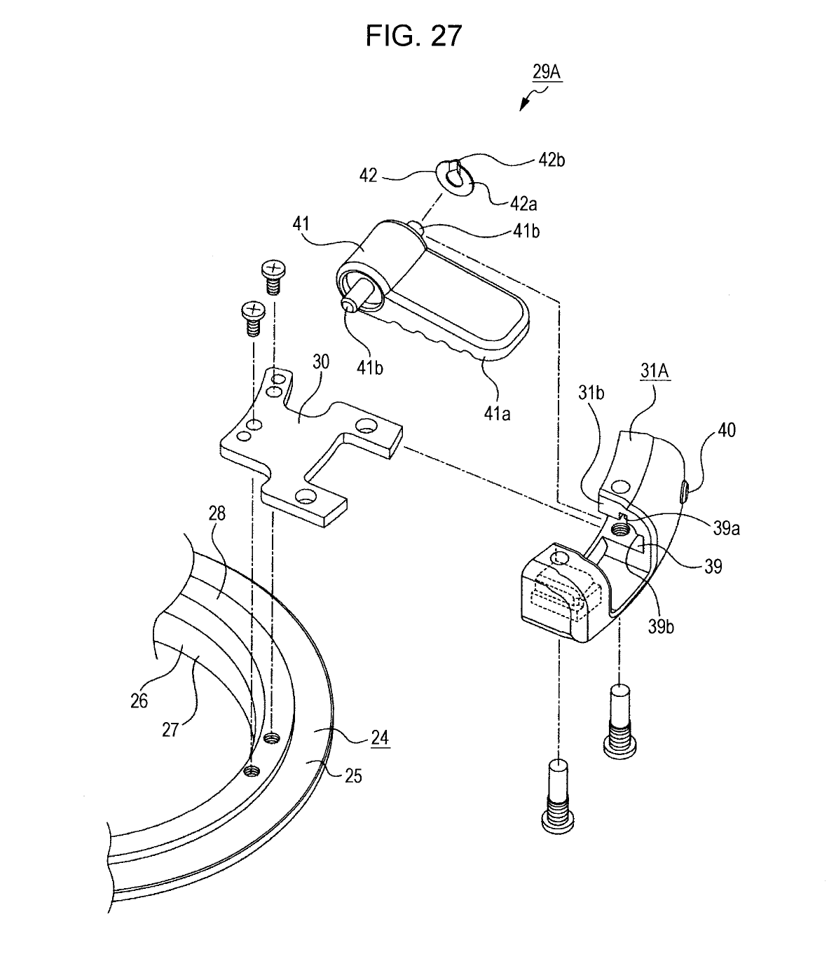

To the front face of the connecting face portion 28 in the movable ring 26, an operating lever 29A is connected with a screw or the like (see FIGS. 26 and 27).

The operating lever 29A has a connecting arm 30 and an operated section 31A attached to one end of the connecting arm 30.

To the connecting arm 30 in the operating lever 29A, as is the case with the connecting arm 30 in the operating lever 29, the spring case 32 in which the biasing spring 35 and the click ball 36 are disposed may be attached. However, in the following description of the operating lever 29A, descriptions of the spring case 32 and the like are omitted.

The operated section 31A is formed as a box having an opening in an inward (right-hand) part thereof and is placed in the movement slit 22 by being attached to the outside end of the connecting arm 30 with a screw or the like.

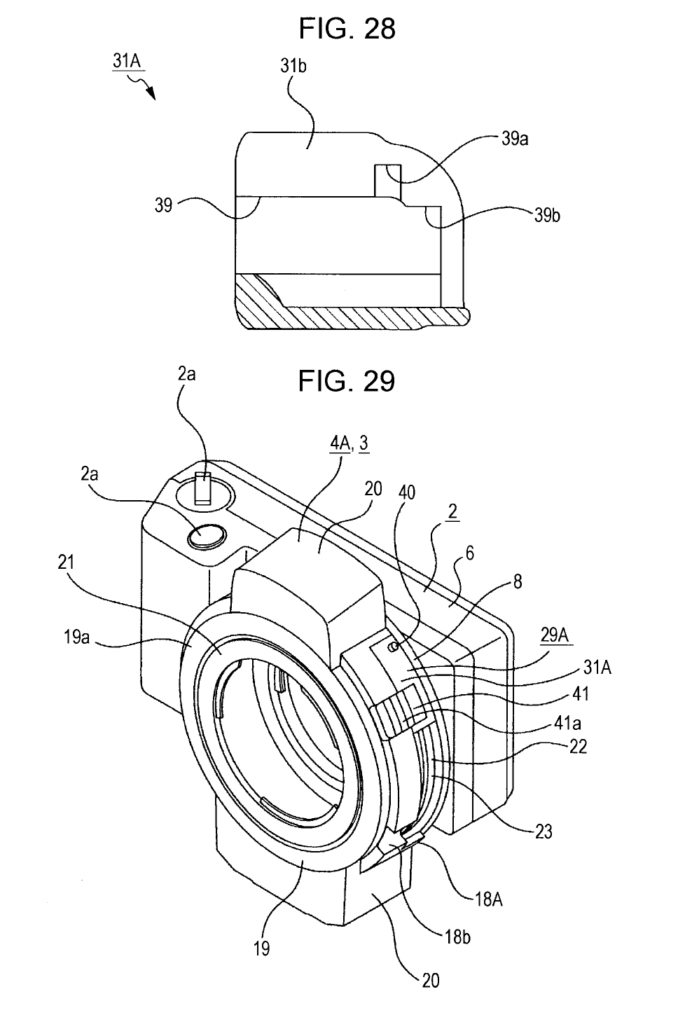

A recessed portion formed in an inward part of the operated section 31A is formed as an insertion recessed portion 39 (see FIGS. 27 and 28). In the insertion recessed portion 39, a first engagement groove 39a formed to face the back side and a second engagement groove 39b which is located away from the first engagement groove 39a on the back side of the first engagement groove 39a, the second engagement groove 39b extending laterally, are formed.

In the operated section 31A, a placement recessed portion 31b formed to face the front side is formed.

On the outer surface of the operated section 31A, a projection 40 is provided (see FIGS. 25 and 26), and the projection 40 functions as a mark allowing the projection 40 to be properly positioned at the positioning section 10a of the mount ring 10 when the adapter 4A is attached to the device main body 2. A predetermined color such as white is given to the projection 40 to make the projection 40 more prominent than other portions.

On the operated section 31A, a locking arm 41 is turnably supported (see FIGS. 26 to 28). The locking arm 41 is formed of a turning operation section 41a and supporting point shaft sections 41b and 41b, each jutting in a substantially vertical direction from one end of the turning operation section 41a.

The locking arm 41 is turnably supported on the operated section 31A by the supporting point shaft sections 41b and 41b which are inserted into the insertion recessed portion 39 and used as supporting points.

To a portion around the supporting point shaft section 41b on a top face of the locking arm 41, a click member 42 is fixed. The click member 42 is formed of a fixed section 42a formed as a substantially circular ring and an engagement section 42b jutting upward from the fixed section 42a. The engagement section 42b can be elastically deformed with respect to the fixed section 42a. The click member 42 is disposed in the placement recessed portion 31b in a state in which the fixed section 42a is fixed to the top face of the locking arm 41 and the locking arm 41 is supported on the operated section 31A. One of the supporting point shaft sections 41b of the locking arm 41 is placed through the click member 42.

The operated section 31A of the operating lever 29A is movable in the movement slit 22 and is moved between a first locked position which is an upper movement end and a second locked position which is a lower movement end. The movable ring 26 is rotated with the movement of the operating lever 29A.

Operation Performed when Adapter According to Modified Example is Attached to or Detached from Device Main Body

Hereinafter, the operation performed when the adapter 4A is attached to or detached from the device main body 2 will be described (see FIGS. 29 to 35). When the adapter 4A is attached to or detached from the device main body 2, the bayonet connection method by which the adapter 4A is properly positioned on the device main body 2 and the whole of the adapter 4A is rotated or the spigot connection method by which the adapter 4A is properly positioned on the device main body 2 and the operating lever 29A is operated can be selected.

Since attachment or detachment of the adapter 4A to or from the device main body 2 by the bayonet connection method is performed as in the adapter 4 in a state in which the operating lever 29A is kept in the second locked position which is a lower movement end, the description thereof is omitted.

Incidentally, the adapter 4A is properly positioned on the device main body 2 in the bayonet connection method by placing the projection 40 of the locking arm 41 directly in front of the positioning section 10a of the mount ring 10.

Next, attachment and detachment by the spigot connection method will be described.

When the adapter 4A is attached to the device main body 2 by the spigot connection method, first, the adapter 4A is put into a state in which the adapter 4A is in the first locked position (see FIG. 29).

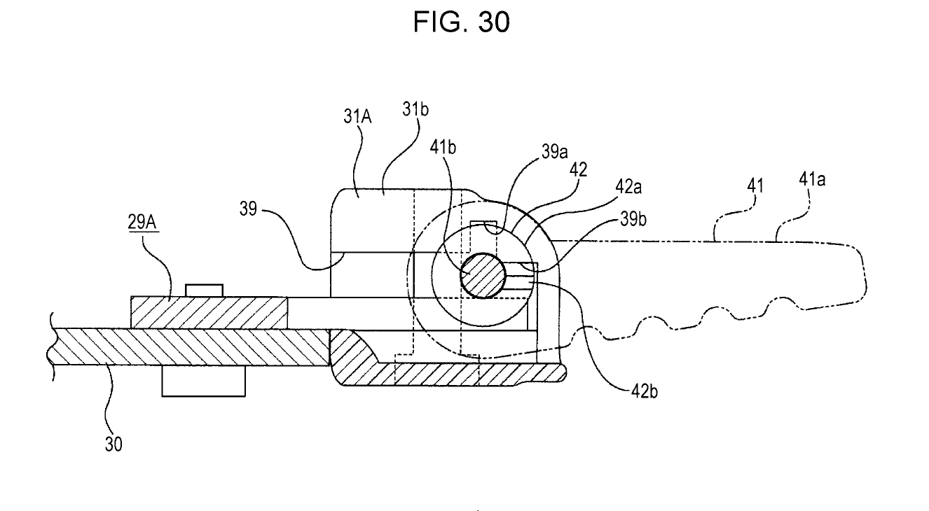

At this time, the turning operation section 41a of the locking arm 41 is fitted into the first locking recessed portion 18a of the body 18A in the device main body 2, and the rotation of the operating lever 29A with respect to the body 18A is regulated. In a state in which the turning operation section 41a is fitted into the first locking recessed portion 18a, the engagement section 42b of the click member 42 engages the second engagement groove 39b of the insertion recessed portion 39 formed in the operated section 31A (see FIG. 30).

Next, the projection 40 of the operating lever 29A in the adapter 4A, the adapter 4A functioning as a mark, is placed directly in front of the positioning section 10a of the mount ring 10 in the device main body 2, and the adapter 4A is properly positioned on the device main body 2.

In a state in which the projection 40 functioning as a mark is placed directly in front of the positioning section 10a and the adapter 4A is properly positioned on the device main body 2 as described above, the engagement sections 27a, 27b, and 27c in the ring section 27 of the movable ring 26 are placed to face the insertion sections 15, 16, and 17, respectively, formed between the engagement projections 12, 13, and 14.

The projection 40 functioning as a mark is provided in the operating lever 29A. This makes it unnecessary to provide a special portion for providing a mark in the adapter 4A and makes it possible to position the adapter 4A properly on the device main body 2 reliably while reducing the number of parts and simplifying the mechanism.

Next, the engagement sections 27a, 27b, and 27c of the movable ring 26 are inserted into the insertion sections 15, 16, and 17, respectively, and the fixed ring 25 is pressed against the mount ring 10 of the device main body 2 from the front.

When the fixed ring 25 of the adapter 4A is pressed against the mount ring 10 of the device main body 2 from the front, the regulating projection 11b of the release button 11 is inserted into the rotation regulating hole 25c of the fixed ring 25, and the rotation of the adapter 4A with respect to the device main body 2 is regulated.

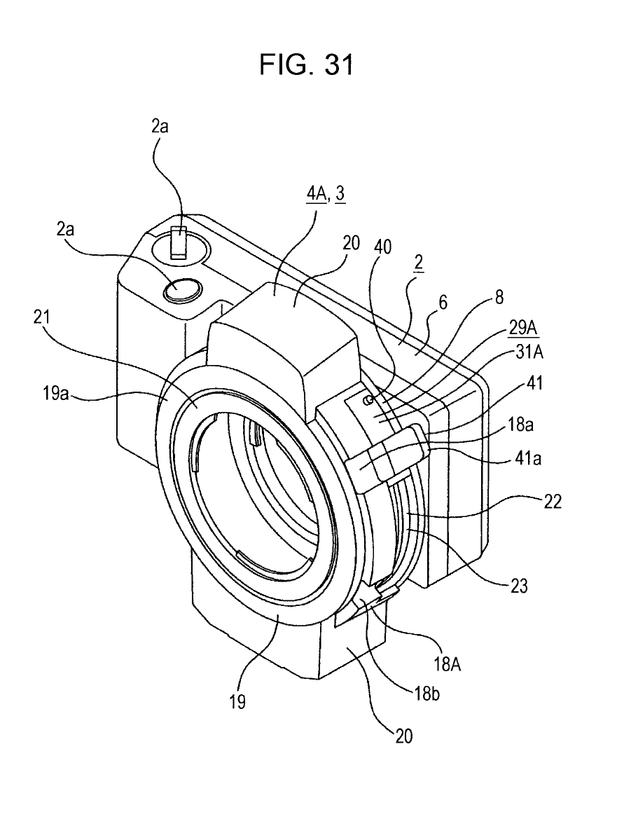

Next, the turning operation section 41a of the locking arm 41 is turned and drawn out of the first locking recessed portion 18a (see FIG. 31).

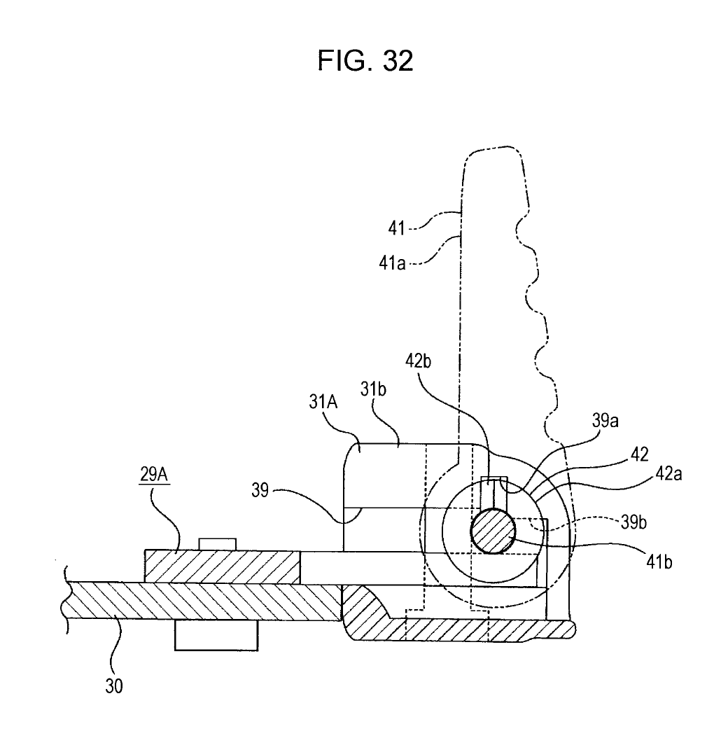

When the turning operation section 41a is turned, the click member 42 is turned with the turning operation section 41a, and the engagement section 42b is elastically deformed as a result of being slid on the wall surface of the operated section 31A. When the turning operation section 41a is drawn out of the first locking recessed portion 18a, the engagement section 42b is elastically restored to an original shape and engages the first engagement groove 39a of the operated section 31A (see FIG. 32). At this time, the movement produced when the turning operation section 41a is drawn out of the first locking recessed portion 18a is transmitted to the user as a so-called feeling of having made a click.

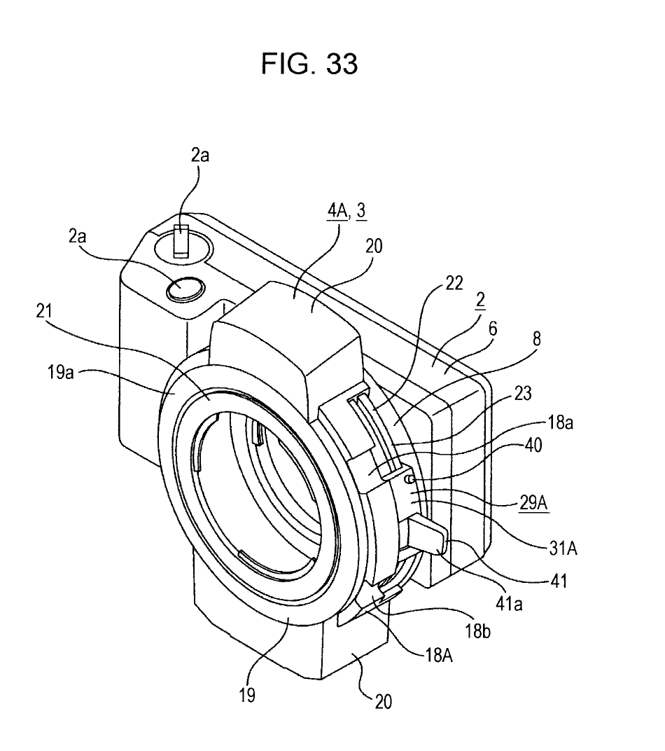

Then, the operating lever 29A is operated from the first locked position to the second locked position (see FIG. 33). When the operating lever 29A is operated to the second locked position, the movable ring 26 is rotated with the operating lever 29A, and the engagement sections 27a, 27b, and 27c of the movable ring 26 are inserted into the space behind the engagement projections 12, 13, and 14, respectively.

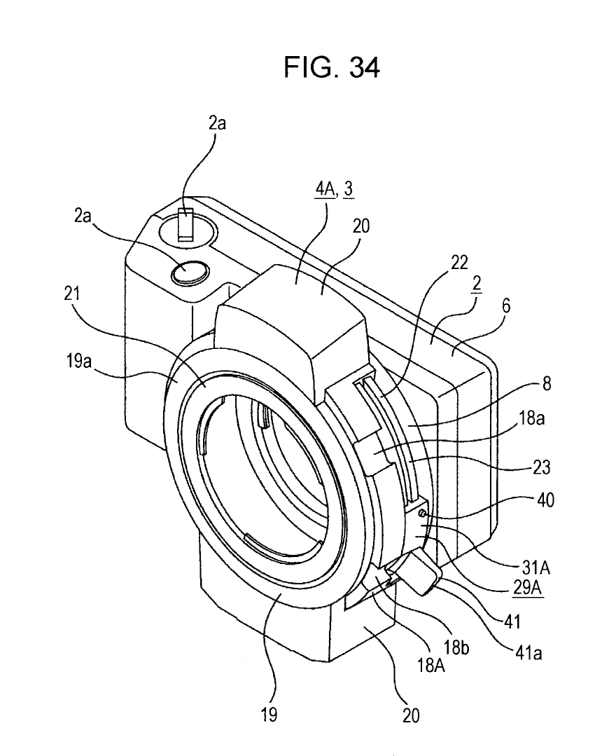

The operating lever 29A is continuously operated and moved to the second locked position (see FIG. 34). When the operating lever 29A is moved to the second locked position, the engagement sections 27a, 27b, and 27c of the movable ring 26 are entirely inserted into the space behind the engagement projections 12, 13, and 14, respectively, and engage the engagement projections 12, 13, and 14, respectively.

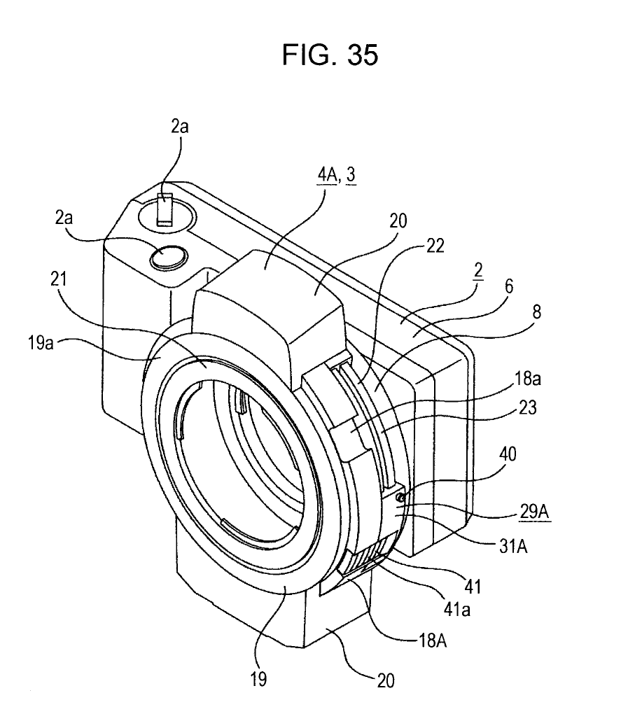

Next, the locking arm 41 is turned, the turning operation section 41a is fitted into the second locking recessed portion 18b of the body 18A, and the operating lever 29A is locked. As a result, the rotation of the operating lever 29A with respect to the body 18A is regulated (see FIG. 35).

When the locking arm 41 is turned, the click member 42 is turned with the turning operation section 41a, and the engagement section 42b is elastically deformed as a result of being slid on the wall surface of the operated section 31A. When the turning operation section 41a is fitted into the second locking recessed portion 18b, the engagement section 42b is elastically restored to an original shape and engages the second engagement groove 39b of the operated section 31A (see FIG. 30). At this time, the movement produced when the turning operation section 41a is fitted into the second locking recessed portion 18b and the operating lever 29A is locked in the body 18A is transmitted to the user as a so-called feeling of having made a click.

As described above, since the movement produced when the operating lever 29A is moved to the second locked position and the operating lever 29A is locked in the body 18A is transmitted to the user, it is possible to enhance usability.

In a state in which the adapter 4A is locked in the device main body 2, the connection of the adapter 4A is connected to the contact section of the device main body 2, allowing the device main body 2, the adapter 4A, and the interchangeable lens 5 to perform communication with one another.

When the adapter 4A is detached from the device main body 2, first, the locking arm 41 is turned and the turning operation section 41a is drawn out of the second locking recessed portion 18b of the body 18A. When the turning operation section 41a is drawn out of the second locking recessed portion 18b, the operating lever 29A is released.

Next, in a state in which the operating lever 29A is released, the operating lever 29A is operated and moved from the second locked position to the first locked position. When the operating lever 29A is moved to the second locked position, the engagement sections 27a, 27b, and 27c of the movable ring 26 are removed from engagement with the engagement projections 12, 13, and 14.

Then, the locking arm 41 is turned, the turning operation section 41a is fitted into the first locking recessed portion 18a of the body 18A, and the operating lever 29A is locked. As a result, the rotation of the operating lever 29A with respect to the body 18A is regulated.

When the locking arm 41 is turned, the click member 42 is turned with the turning operation section 41a, and the engagement section 42b is elastically deformed as a result of being slid on the wall surface of the operated section 31A. When the turning operation section 41a is fitted into the first locking recessed portion 18a, the engagement section 42b is elastically restored to an original shape and engages the second engagement groove 39b of the operated section 31A. At this time, the movement produced when the turning operation section 41a is fitted into the first locking recessed portion 18a and the operating lever 29A is locked in the body 18A is transmitted to the user as a so-called feeling of having made a click.

Then, the adapter 4A is drawn forward out of the device main body 2. In this way, the adapter 4A is detached from the device main body 2.

### Embodiment of Imaging Device

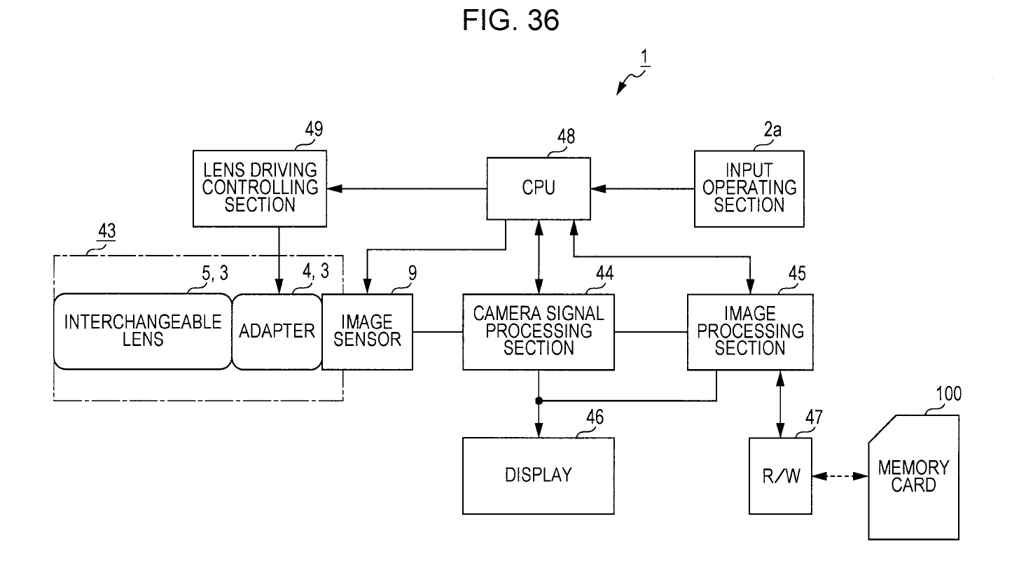

Hereinafter, a block diagram of a digital still camera which is an imaging device according to an embodiment of the present technology is shown (see FIG. 36).

The imaging device (the digital still camera) 1 includes a camera block 43 having an imaging function, a camera signal processing section 44 performing signal processing such as analog-digital conversion of the taken image signal, and an image processing section 45 performing recording/reproduction processing on the image signal. Moreover, the imaging device 1 includes a display 46 displaying the taken image and the like, a R/W (reader/writer) 47 performing the writing and reading of the image signal to and from a memory card 100, a CPU (central processing unit) 48 performing overall control of the imaging device 1, input operating sections 2a, 2a, . . . and the like such as various switches by which predetermined operations are performed by the user, and a lens driving controlling section 49 controlling the driving of the lenses disposed in the camera block 43.

The camera block 43 is formed of the interchangeable lens 5, the adapter 4, the image sensor 9, and the like.

The camera signal processing section 44 performs various kinds of signal processing such as conversion from the output signal from the image sensor 9 to a digital signal, noise removal, image quality correction, conversion to a brightness/color-difference signal, etc.

The image processing section 45 performs compression coding/decompression decoding of the image signal based on a predetermined image data format, conversion of data specifications such as resolution, and the like.

The display 46 has the function of displaying the state of operation performed by the user on the input operating sections 2a, 2a, . . . and the like and various data such as the taken image.

The R/W 47 writes the image data coded by the image processing section 45 into the memory card 100 and reads the image data recorded on the memory card 100.

The CPU 48 functions as a control processing section controlling the circuit blocks provided in the imaging device 1 and controls the circuit blocks based on an instruction input signal or the like from the input operating sections 2a, 2a, . . . and the like.

The input operating sections 2a, 2a, . . . and the like are formed of, for example, a power button, a shutter button, a mode switching knob, and a zoom switch and output, to the CPU 48, an instruction input signal in accordance with the operation performed by the user.

The lens driving controlling section 49 controls a motor etc. that drives the lenses of the interchangeable lens 5 via the adapter 4 based on the control signal from the CPU 48. Incidentally, the lens driving controlling section 49 may be disposed in the adapter 4.

The memory card 100 is, for example, a semiconductor memory that can be attached to or detached from a slot connected to the R/W 47.

Hereinafter, the operation in the imaging device 1 will be described.

In a shooting waiting state, under the control of the CPU 48, the image signal taken by the camera block 43 is output to the display 46 via the camera signal processing section 44 and is displayed as a camera-through image. Moreover, when an instruction input signal for zooming is input from the input operating sections 2a, 2a, and the like, the CPU 48 outputs a control signal to the lens driving controlling section 49, and a predetermined lens of the interchangeable lens 5 is moved based on the control of the lens driving controlling section 49.

When an unillustrated shutter of the camera block 43 is operated by an instruction input signal from the input operating sections 2a, 2a, and the like, the taken image signal is output from the camera signal processing section 44 to the image processing section 45, subjected to compression coding, and converted into digital data of a predetermined data format. The data obtained by conversion is output to the R/W 47 and written into the memory card 100.

Zooming is performed as follows. When, for example, the input operating section (the zoom switch) 2a is operated, the lens driving controlling section 49 moves a predetermined lens of the interchangeable lens 5 based on a control signal from the CPU 48 to perform zooming.

Focusing is performed as follows. When, for example, the input operating section (the shutter button) 2a is pressed halfway down or pressed all the way down to perform recording (shooting), the lens driving controlling section 49 moves a predetermined lens of the interchangeable lens 5 based on the control signal from the CPU 48 to perform focusing.

When the image data recorded on the memory card 100 is reproduced, predetermined image data is read from the memory card 100 by the R/W 47 in accordance with the operation performed on the input operating sections 2a, 2a, . . . and the like, and subjected to decompression decoding by the image processing section 45. Then, the reproduced image signal is output to the display 46, and a reproduced image is displayed.

### CONCLUSION

As described above, the bayonet connection method by which the adapter 4 or 4A is rotated with respect to the device main body 2 to connect the movable ring 26 functioning as a connecting section to the mount ring 10 functioning as a mount section or the spigot connection method by which the operating lever 29 or 29A is operated to connect the movable ring 26 to the mount ring 10 can be selected.

Therefore, by selecting a method for attaching the adapter 4 or 4A to the device main body 2 in accordance with the type of accessory or the status of use, the accessory can be attached to or detached from the device main body 2 more easily.

Moreover, the movable ring 26 is rotated with the rotation of the body 18 or 18A and the movable ring 26 is connected to the mount ring 10 by the bayonet connection method, and the movable ring 26 is rotated by the operation of the operating lever 29 or 29A and the movable ring 26 is connected to the mount ring 10 by the spigot connection method.

Therefore, it is possible to attach the adapter 4 or 4A to the device main body 2 with a simple structure by the bayonet connection method and the spigot connection method.

Furthermore, when the adapter 4 or 4A is attached to the device main body 2, the rotation regulating hole 25c engages the regulating projection 11b, and the position of the adapter 4 or 4A with respect to the device main body 2 is regulated.

Therefore, both the bayonet connection method and the spigot connection method make it possible to attach the adapter 4 or 4A to the device main body 2 with stability.

In addition, in a state in which the operating lever 29 or 29A is present in the locked position, the adapter 4 or 4A is attached to the device main body 2 by the bayonet connection method.

Therefore, since the operating lever 29 or 29A is locked when the adapter 4 or 4A is attached to the device main body 2 by the bayonet connection method, the movable ring 26 is not rotated. This makes it possible to prevent the adapter 4 or 4A from becoming accidentally detached from the device main body 2.

In addition, the operating lever 29 or 29A is rotated to the locked position, and the adapter 4 or 4A is attached to the device main body 2 by the spigot connection method.

Therefore, since the operating lever 29 or 29A is locked when the adapter 4 or 4A is attached to the device main body 2 by the spigot connection method, the movable ring 26 is not rotated. This makes it possible to prevent the adapter 4 or 4A from becoming accidentally detached from the device main body 2.

### Embodiment of Present Technology

The embodiment of the present technology can adopt the following configuration.

(1) An accessory including: a connecting section which is connected to a mount section provided in a device main body; an operating lever operated and moved in a predetermined direction; and a body supporting the operating lever; wherein a bayonet connection method by which the accessory is properly positioned on the device main body and the whole of the accessory is rotated to connect the connecting section to the mount section and attach the accessory to the device main body or a spigot connection method by which the accessory is properly positioned on the device main body and the operating lever is operated to connect the connecting section to the mount section and attach the accessory to the device main body can be selected.

(2) The accessory described in (1) above, wherein a mark for properly positioning the accessory on the device main body is provided in the operating lever.

(3) The accessory described in (1) or (2) above, wherein the connecting section is rotatably supported on the body, the operating lever and the connecting section can be rotated together, the operating lever and the connecting section are rotated together with the rotation of the body to connect the connecting section to the mount section by the bayonet connection method, and the operating lever and the connecting section are rotated together by the operation of the operating lever to connect the connecting section to the mount section by the spigot connection method.

(4) The accessory described in any one of (1) to (3) above, wherein a regulated section regulating the position of the accessory with respect to the device main body by engaging a regulating section provided in the device main body is provided, and, when the connecting section is connected to the mount section and the accessory is attached to the device main body, the position of the accessory with respect to the device main body is regulated as a result of the regulated section engaging the regulating section.

(5) The accessory described in (3) or (4) above, wherein the operating lever can be operated between a locked position in which the operating lever is locked in the body and an unlocked position in which the operating lever is rotatable with respect to the body, and, in a state in which the operating lever is in the locked position, the connecting section is connected to the mount section and the accessory is attached to the device main body by the bayonet connection method.

(6) The accessory described in (3) or (4) above, wherein the operating lever can be operated between a locked position in which the operating lever is locked in the body and an unlocked position in which the operating lever is rotatable with respect to the body, and the operating lever is operated and moved to the locked position and the connecting section is connected to the mount section and the accessory is attached to the device main body by the spigot connection method.

(7) The accessory described in (6) above, wherein a click ball moved with the movement of the operating lever, a fixed section having a rolling contact surface on which the click ball is rolled, the fixed section having formed therein a fit recessed portion into which the click ball can be fitted, and a biasing spring pressing the click ball against the rolling contact surface are provided, and the click ball is fitted into the fit recessed portion when the operating lever is moved to the locked position.

(8) An imaging device including: a device main body in which a mount section is provided; and an accessory having a connecting section which is connected to the mount section, an operating lever operated and moved in a predetermined direction, and a body supporting the operating lever; wherein a bayonet connection method by which the accessory is properly positioned on the device main body and the whole of the accessory is rotated to connect the connecting section to the mount section and attach the accessory to the device main body or a spigot connection method by which the accessory is properly positioned on the device main body and the operating lever is operated to connect the connecting section to the mount section and attach the accessory to the device main body can be selected.

It should be understood that the specific shapes and structures of the sections described in the above preferred embodiment of the present technology are merely examples of embodiments in implementing the present technology and are not meant to limit the technical scope of the present technology in any way.

The present disclosure contains subject matter related to that disclosed in Japanese Priority Patent Application JP 2011-232776 filed in the Japan Patent Office on Oct. 24, 2011, the entire contents of which are hereby incorporated by reference.

What is claimed is:

1. An accessory comprising:
a connecting section which is connected to a mount section provided in a device main body;
an operating lever operated and moved in a predetermined direction; and
a body supporting the operating lever; wherein
a bayonet connection method by which the accessory is properly positioned on the device main body and the whole of the accessory is rotated to connect the connecting section to the mount section and attach the accessory to the device main body or a spigot connection method by which the accessory is properly positioned on the device main body and the operating lever is operated to connect the connecting section to the mount section and attach the accessory to the device main body can be selected.

2. The accessory according to claim 1, wherein
a mark for properly positioning the accessory on the device main body is provided in the operating lever.

3. The accessory according to claim 1, wherein
the connecting section is rotatably supported on the body,
the operating lever and the connecting section can be rotated together,
the operating lever and the connecting section are rotated together with the rotation of the body to connect the connecting section to the mount section by the bayonet connection method, and
the operating lever and the connecting section are rotated together by the operation of the operating lever to connect the connecting section to the mount section by the spigot connection method.

4. The accessory according to claim 1, further comprising:
a regulated section regulating a position of the accessory with respect to the device main body by engaging a regulating section provided in the device main body; wherein
when the connecting section is connected to the mount section and the accessory is attached to the device main body, the position of the accessory with respect to the device main body is regulated as a result of the regulated section engaging the regulating section.

5. The accessory according to claim 3, wherein
the operating lever can be operated between a locked position in which the operating lever is locked in the body and an unlocked position in which the operating lever is rotatable with respect to the body, and
in a state in which the operating lever is in the locked position, the connecting section is connected to the mount section and the accessory is attached to the device main body by the bayonet connection method.

6. The accessory according to claim 3, wherein
the operating lever can be operated between a locked position in which the operating lever is locked in the body and an unlocked position in which the operating lever is rotatable with respect to the body, and
the operating lever is operated and moved to the locked position and the connecting section is connected to the mount section and the accessory is attached to the device main body by the spigot connection method.

7. The accessory according to claim 6, further comprising:
a click ball moved with the movement of the operating lever;
a fixed section having a rolling contact surface on which the click ball is rolled, the fixed section having formed therein a fit recessed portion into which the click ball can be fitted; and
a biasing spring pressing the click ball against the rolling contact surface; wherein
the click ball is fitted into the fit recessed portion when the operating lever is moved to the locked position.

8. An imaging device comprising:
a device main body in which a mount section is provided; and
an accessory having a connecting section which is connected to the mount section, an operating lever operated and moved in a predetermined direction, and a body supporting the operating lever; wherein
a bayonet connection method by which the accessory is properly positioned on the device main body and the whole of the accessory is rotated to connect the connecting section to the mount section and attach the accessory to the device main body or a spigot connection method by which the accessory is properly positioned on the device main body and the operating lever is operated to connect the connecting section to the mount section and attach the accessory to the device main body can be selected.
